(19) United States
(12) Patent Application Publication
(10) Pub. No.: US 2010/0020664 A1
(43) Pub. Date: Jan. 28, 2010

(54) RECORDING STRATEGY ADJUSTING METHOD AND OPTICAL DISC RECORDING/REPRODUCING DEVICE

(75) Inventors: Masaki Nakano, Tokyo (JP); Masatsugu Ogawa, Tokyo (JP)

Correspondence Address: YOUNG & THOMPSON, 209 Madison Street, Suite 500, Alexandria, VA, 22314, US

(73) Assignee: NEC CORPORATION, Tokyo (JP)

(21) Appl. No.: 12/524,106

(22) PCT Filed: Jan. 18, 2008
(86) PCT No.: PCT/JP2008/050580

§ 371 Date: Aug. 4, 2009

(30) Foreign Application Priority Data
Jan. 22, 2007 (JP) 2007-011318

(51) Int. Cl. G11B 27/36

(52) U.S. Cl. 369/59.11; G9B/27.052

(57) ABSTRACT

A recording strategy for specifying an output waveform of a laser beam to be applied to a recording layer of an information recording medium is adjusted by the following recording strategy adjusting method. The recording strategy adjusting method includes a base strategy determining step of determining a basic recording strategy; a first top pulse width setting step wherein the shortest mark in a pattern row formed on the recording layer of the information recording medium is specified after the base strategy determining step, and the width of a top pulse, i.e., a pulse for recording the shortest mark, is set; and a step of adjusting a power, including a recording power and a bias power, for recording.

### TECHNICAL FIELD

The present invention relates to a recording strategy adjustment method and an optical disc recording and reproducing device.

### BACKGROUND ART

Recently, optical disc devices have been often used for a peripheral device of an information processing device and an AV (Audio Visual) apparatus recently. The optical disc device can read information recorded to an optical disc and write information to the optical disc by using laser light.

On an optical disc, recording marks are formed thereon by applying heat to a recording layer on the optical disc to change characteristics of material constituting the recording layer. The recording marks are formed on the basis of recording data. It is important to control the heat applied to the recording layer in order to appropriately form recording marks corresponding to recording data. When the calorific value applied to the recording layer is small when a specific recording mark is formed, the recording mark cannot be adequately formed. When the calorific value applied to the recording layer is large, the form of the recording mark becomes inappropriate. In addition, it exerts an undesirable influence on the formation of other neighboring recording marks.

Accordingly, it is very important in optical disc devices to appropriately control the output of laser light. The control of the laser light is carried out by changing the shape of waveform, which is called the recording strategy. The waveform represented by the recording strategy shows output levels of the record power, the bias power, and the like by the amplitude and shows irradiation time of the laser light for the mark formation by the pulse width (a temporal direction) of the laser pulse for recording.

FIG. 1A to FIG. 1F are views showing types of the recording strategies. FIG. 1A shows a pulse train type recording strategy. FIG. 1B shows a simple rectangle form type recording strategy. FIG. 1C shows a rectangle form recording strategy whose top is emphasized. FIG. 1D shows a recording strategy whose top and last are emphasized. FIG. 1E shows a recording strategy where a record power of each pulse is independent. FIG. 1F is a pulse train type recording strategy having power levels of three values, which is mainly used for rewritable media conventionally.

As shown in FIGS. 1A to 1F, there are various types of the recording strategies, and there are cases where the power level and the pulse shape vary depending on the medium to be recorded. For example, in the DVD-R, a write once optical disc that is recordable once, the rectangle form type recording strategy is employed. In addition, in the DVD-RW, a repeatedly-rewritable optical disc, the multi-pulse type recording strategy is employed. Moreover, in a write once medium, the output level in a space portion in which no recording mark is formed is called the bias power. In the rewritable optical disc, the output level in the space portion in which no recording mark is formed is called the erasing power because of an operation to erase previously-existing recording marks.

In a case of the HD DVD (High Definition DVD) that is a next-generation DVD, the write once HD DVD-R and the rewritable HD DVD-RW or HD DVD-RAM (hereinafter referred to as the HD DVD family when referring them totally) employ the multi-pulse type recording strategy. The recording strategy greatly influences the recording and reproducing performance of the optical disc. Accordingly, many types of recording strategy adjustment methods are known.

Japanese Laid-Open Patent Application JP-P2000-182244A describes a technique for: allocating several levels to parameters of the record power and the recording strategy; performing experiments on each combination in a comprehensive manner; and selecting the most suitable strategy. In addition, Japanese Laid-Open Patent Application JP-P2000-30254A describes a technique for: separately carrying out adjustment of a parameter of the recording strategy and adjustment of the record power; and determining the record power by referring a theoretical mark length as a guideline. Moreover, Japanese Laid-Open Patent Application JP-P2001-511289A describes a technique for: measuring an anterior edge jitter and a posterior edge jitter from a reproduced signal in test recording-and-reproducing; and separately determining the anterior edge jitter and the posterior edge jitter by adjusting parameters which influence only the anterior edge or the posterior edge (an individual power of recording strategy configuration pulse, a combination of shapes of waveforms, and the like).

Japanese Laid-Open Patent Application JP-P2001-155340A describes a technique that is applicable to the CAV (Constant Angular Velocity) recording, the ZCAV (Zoned CAV) recording, or the CLV (Constant Linear Velocity) recording of any velocity and that carries out the recording in a simple control method. In this technique, when the recording mark is formed on an optical recording medium having a variable recording linear velocity by the multi-pulse method, the record power is allocated with respect to a pulse train for forming the recording mark for each type of the pulse on the basis of: an emission pattern optimized at the configurable highest linear velocity; and a pulse length configuration, and thus the above-mentioned pulse train is generated by more than 2 different record powers. Then, each of the record powers is controlled depending on: the recording linear velocity; or a recording position of an optical recording medium. As in this technique, even if the record power in accordance with the recording linear velocity or the recording position is controlled, the recording can be carried out in low jitters within a practical linear velocity even in a case where an emission pulse length of the recording strategy is fixed to be constant.

Japanese Laid-Open Patent Application JP-P2003-203343A discloses a technique for adjusting the recording strategies of the CD-R and the DVD-R. Japanese Laid-Open Patent Application JP-P2005-216347A discloses a technique for adjusting the recording strategy of the DVD-R.

In the high-density next-generation optical disc (the HD DVD and the BD (Blu-ray Disc)), the reading and the writing to the disc are carried out by applying laser light whose light source wavelength is about 400 to 410 nm (a short wavelength laser). Among the recordable media accepting the above-mentioned short wavelength laser, there are roughly two types of recording layers of the write once media; one employs inorganic material and the other employs organic material. The inorganic material has the H/L (High-to-Low) characteristic that lowers reflectivity of a recording mark portion formed by irradiating a laser light than reflectivity before the laser light irradiation. On the other hand, the organic material has the L/H (Low-to-High) characteristic that increases reflectivity of the recording mark portion.

Japanese Laid-Open Patent Application JP-P2005-116058A describes a technique regarding a write once medium using inorganic material. Japanese Laid-Open Patent Application JP-P2005-297407A describes a technique regarding a write once medium using organic dye material. In addition, Japanese Laid-Open Patent Application JP-P 2005-297407A describes a recording waveform that includes a record power and a bias power and has the bias power in a space portion in response to the high-density next-generation optical disc. The shape of this waveform is equivalent to that used for rewritable media, and it can be found that, unlike conventional ways, a bias power higher than before is required in next-generation write once media.

The HD DVD which is a next generation DVD has much higher recording density (more than three times) as compared with the conventional DVD, and employs the PRML (Partial Response Maximum Likelihood) technique to read a signal. The PRML technique is known as a technique for carrying out the decoding by: preliminarily estimating interference between record signals; and forecasting a probable signal pattern. For example, “Nakano et al., Signal Processing Technologies for next-generation DVD, ITE technical report, Vol. 27, No. 43, pp. 13-16, MMS2003-48, CE2003-53 (July, 2003)” describes a technique regarding the PRML. For the HD DVD, the PRML categorized in the PR (12221) being a very large interference class is used. That is to say, it means that states of an anterior edge and a posterior edge of recording marks existing before and after a certain mark greatly influence the reproduced signal. In addition, this means that adjustment of the recording strategy will be extremely delicate.

In a case of carrying out the PRML detection, there are some indexes used for evaluating a signal quality of reproduced waveform. For example, in Japanese Journal of Applied Physics Vol. 43, No. 7B, 2004, pp. 4859-4862 “Signal-to-Noise Ratio in a PRML Detection”. S. OHKUBO et al., a technique regarding the PRSNR (Partial Response Signal to Noise ratio) is described as one example thereof.

This is an index for the alternative to the jitter used for evaluating a signal quality of reproduced waveform of conventional DVDs. In a high density optical disc such as the HD DVD, it is sometimes difficult for a conventional jitter to evaluate a signal quality of reproduced waveform The PRSNR is an index employed as a signal quality evaluation index alternative to the jitter in the HD DVD family, and is an SNR in the PRML. The PRSNR can be converted into an error rate, it means that the higher this value is, the more superior the signal quality is, and thereby the PRSNR is opposite to the jitter and the error rate. In addition, it has been known that the value is required to be 15 or more as a standard of performance in the PRSNR.

In addition, as another method for evaluating quality of a reproduced waveform, there is a method for directly obtaining the number of error bytes, an error rate, and a PI error. The PI error means the total number of rows in which errors have been detected on the basis of the parity on an inner side of the ECC (Error Correction Code), and is used in qualitatively almost the same meaning as that of the error rate. In the HD DVD, a modulation code that is also different from that of conventional DVDs is used. That is a modulation code called the ETM (Eight to Twelve Modulation) whose shortest mark or shortest space length is 2 T (T is a channel clock period). Meanwhile, the conventional DVD uses a modulation code called the EFM whose shortest mark or shortest space length is 3 T. Accordingly, there configuration of the recording strategy are different from each other.

Additionally, in the HD DVD, a modulation code that is also different from that of conventional DVDs is used. That is a modulation code called the ETM (Eight to Twelve Modulation) whose shortest mark or shortest space length is 2 T (T is a channel clock period). Meanwhile, the conventional DVD uses a modulation code called the EFM whose shortest mark or shortest space length is 3 T. Accordingly, there configuration of the recording strategy are different from each other. For example, in a case of the DVD-R, when a recording mark of length kT (k is a natural number of 3 or more) is recorded, the recording is sometimes carried out by k-2 pulses, however, in a case of the HD DVD-R, since the shortest recording mark length is 2 T, an output pulse cannot exist in 2 T when the recording is carried out by the k-2 pulses. That is, the recording has to be carried out by at least k-1 pulses. This means that is not simply an argument about the number of pulses but requirements to originally change a way of thinking about the configuration of the recording strategy in the DVD and the HD DVD. That is, knowledge of the DVD cannot be used so effectively.

In a high density optical disc such as the HD DVD, it is required to adjust the recording strategy with high accuracy. In addition, an adjustment suitable for the PRML detection that is not used in conventional DVDs is required. This is because the PRML detection is a detection method positively using an intersymbol interference of recorded marks. In such a case, each parameter of the recording strategy often influences with one another, and it accordingly becomes difficult to obtain an optimum recording strategy through a rough adjustment where each parameter independently influence a signal quality such as the technique described in Japanese Laid-Open Patent Application JP-P2000-182244A. In addition, in a case where a recording mark (or apace) is influenced by recording marks before and after the recording mark because the intersymbol interference rapidly increases due to the high density even when the parameter is adjusted by introducing an index using a theoretical value of the longest mark (there is no difference between widths of a mark and a space), it becomes difficult to obtain an optimum recording strategy even in the technique described in Japanese Laid-Open Patent Application JP-P2000-30254A.

Moreover, also in a technique described in Japanese Laid-Open Patent Application JP-P2001-511289A, it is not defined which edge has to be moved in which pulse. In addition, since the power is ambiguous; whether the power means powers of all pulses or a power of individual pulse, it is not described which adjustment has to be preferentially carried out, and there are so many combinations in a case where all of them are tentatively combined, it is difficult to adjust an optimum recording strategy at a high speed.

Japanese Laid-Open Patent Application JP-P2003-203343A describes that the adjustment is carried out with a fixed record power. But it is difficult to carry out high speed adjustment because a plurality of combinations of a top pulse and a multi-pulse are required. In addition, since a portion to be adjusted and an extent of the adjustment are not described, actual application is difficult. Moreover, the conventional technique is prepared for not the PRML detection but a level slice detection (a binary detection for judging whether the power is larger or weaker than the slice level), thereby cannot be directly used for a system using the PRML.

In addition, the techniques described in Japanese Laid-Open Patent Application JP-P2001-511289A, Japanese Laid-Open Patent Application JP-P2003-203343A, and Japanese Laid-Open Patent Application JP-P2005-216347A are adjustment methods not prepared for the PRML detection, and are old methods using the conventional jitter. In high density optical discs such as the HD DVD, the jitter that is a signal index cannot be measured already. Moreover, unlike the HD DVD, the methods are prepared for a modulation code where a signal of 3 T or more exists, and a configuration of the recording strategy is also different from those of the HD DVD and the like. Additionally, as for the medium, in a write once medium, since the bias power influences the performance thereof, it has been required to consider adjustment thereof. That is, the conventional techniques cannot be directly applied to the HD DVD and the like.

Because of such situations, in a high density system using the PRML such as the HD DVD, it becomes a substantially-major problem on development of the high density optical disc to define in a high density system using the PRML such as the HD DVD: how to adjust the recording strategy; and the order of adjustments of recording strategy parameters.

### DISCLOSURE OF INVENTION

A purpose of a present invention is to provide a technique that is widely applicable for a recording and reproducing device of a high density optical disc and a recording strategy adjustment method to improve the reliability of the recording and reproducing device.

A recording strategy for specifying an output waveform of a laser beam irradiated to a recording layer of an information recording medium is adjusted by the following recording strategy adjustment method. The recording strategy adjustment method includes: a base strategy determination step of determining a basic recording strategy; a first top pulse width set step of specifying a shortest mark in a pattern string formed on a recording layer of the information recording medium after the base strategy determination step, and setting a width of a top pulse being a pulse for recording the shortest mark; and a recording power adjustment step of adjusting a recording power including a record power and a bias power.

It is possible to enhance reliability of a recording and reproducing device according to the present invention as a recording and reproducing device of a high density optical disc and a recording strategy adjustment method.

### BRIEF DESCRIPTION OF DRAWINGS

Some purposes, effects, and features of an above-mentioned invention will be further clear from descriptions of exemplary embodiments in coordination with accompanying drawings, in which:

FIG. 1A is a view showing a type of recording strategy;

FIG. 1B is a view showing a type of recording strategy;

FIG. 1C is a view showing a type of recording strategy;

FIG. 1D is a view showing a type of recording strategy;

FIG. 1E is a view showing a type of recording strategy;

FIG. 1F is a view showing a type of recording strategy;

FIG. 2 is a block diagram exemplifying a configuration of an information recording and reproducing device 1;

FIG. 3 is a block diagram exemplifying a configuration of an RF circuit;

FIG. 4 is a block diagram exemplifying a configuration of an asymmetry corrector;

FIG. 5 is a flowchart exemplifying an operation of a first exemplary embodiment;

FIG. 6 is a waveform chart exemplifying waveforms of a (k)-type pulse train and a (k-1)-type pulse train;

FIG. 7 is a table showing an adjustment result of a case of applying an operation in a first exemplary embodiment;

FIG. 8 is a flowchart exemplifying an operation of a second exemplary embodiment;

FIG. 9 is a table exemplifying an adjustment result obtained by adjusting a recording condition of an optical disc 14;

FIG. 10 is a flowchart exemplifying an operation of a third exemplary embodiment;

FIG. 11 is a table showing an adjustment result obtained by adjusting a recording condition of an optical disc 14;

FIG. 12 is a flowchart exemplifying an operation of a fourth exemplary embodiment;

FIG. 13A is a table being referred to at an all pulse widths uniform adjustment step;

FIG. 13B is a table exemplifying a transition of a reduction rate of a case where expression (1) is not satisfied;

FIG. 14 is a table exemplifying a lineup of performances obtained by matching the performances in a drive device;

FIG. 15 is a flowchart exemplifying an operation of a seventh exemplary embodiment;

FIG. 16 is a waveform chart exemplifying a non multi-waveform;

FIG. 17 is a waveform chart exemplifying a (k-1)-type non multi-waveform and a (k)-type non multi-waveform;

FIG. 18 is a table exemplifying an adjustment result obtained when an execution order of 3 categories, a record power, a multi-pulse width (a representative of a long mark), and a top pulse width accepting a shortest mark is changed;

FIG. 19 is a view showing a correspondence relationship between a record power and a bias power obtained when a combination of a top pulse and another pulse has been changed;

FIG. 20 is a view exemplifying power margins in using respective parameters;

FIG. 21 is a view exemplifying a result obtained by measuring the PRSNR in changing a pulse width to determine a base strategy;

FIG. 22 is a view exemplifying a result obtained when a width of 2 T top pulse is changed (step S102);

FIG. 23 is a view exemplifying a result of adjustment of power for a recording (step S103);

FIG. 24 is a view exemplifying a result of adjustment of power for a recording (step S103);

FIG. 25 is a view exemplifying a result of adjustment of parameters obtained when a basic pulse width is 0.44 T and when the basic pulse width is 0.80 T;

FIG. 26 is a view exemplifying results of measurement of record power margins obtained when the basic pulse width is 0.44 T, 0.56 T, or 0.80 T;

FIG. 27 is a view exemplifying a result obtained in a case where the recording power for a recording is adjusted; and

FIG. 28 is a view exemplifying a result obtained by plotting the PRSNR and an amplitude of 8 T pattern each obtained when the recording power is fixed and a basic pulse width is changed at obtaining a base strategy.

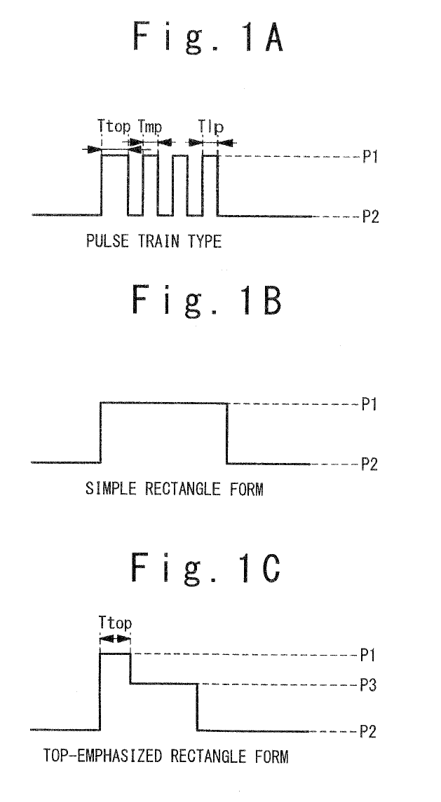

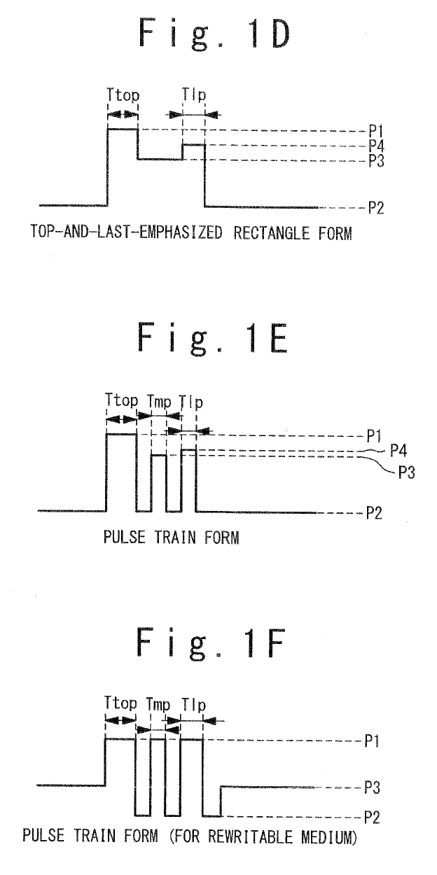

### BEST MODE FOR CARRYING OUT THE INVENTION

### First Exemplary Embodiment

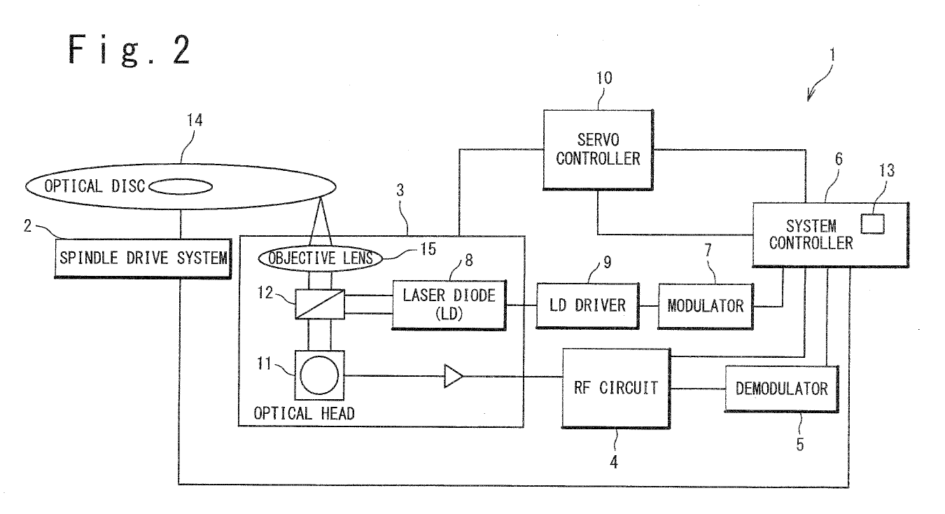

Referring to drawings, some exemplary embodiments of the present invention will be explained. However, the exemplary embodiments do not limit the technical scope of the present invention. FIG. 2 is a block diagram exemplifying a configuration of an information recording and reproducing device 1 according to a first exemplary embodiment. Referring to FIG. 2, the information recording and reproducing device 1 is configured to include: a spindle drive system 2 for driving an optical disc 14; an optical head 3 for emitting a laser beam to the optical disc 14 and detecting the beam; an RF circuit 4 for carrying out a filtering process and the like on an input signal; a demodulator 5 for demodulating the input signal; a system controller 6 for controlling the whole of device; a modulator 7 for modulating a signal to be recorded; a laser diode (LD) 8; a LD driver 9 for driving the laser diode 8; and a servo controller 10 for controlling a servo signal.

Meanwhile, the exemplary embodiment described below will be explained, assuming that the optical disc 14 is a medium accepting a standard of the HD DVD and is a recordable medium writable once (For example, the HD D)VD-R). Additionally, in the exemplary embodiment described below, a case where a physical format of the optical disc 14 is an in-groove format having a bit pitch of 0.15 μm, a track pitch of 0.40 μm will be exemplified.

The optical disc 14 such as the HD DVD is a type of media called as the Low-to-High medium whose reflectivity increases by recording. In the optical disc 14, a guide groove called a pregroove is formed on a discoidal transparent substrate having a thickness of 0.6 mm and a diameter of 12 cm, the substrate being made of polycarbonate. In recording and reproducing information, a laser light of the information recording and reproducing device 1 (an optical disc drive) can scan the disc along this guide groove. The information recording and reproducing device 1 records a pattern string to a recording layer formed on the substrate.

The optical head 3 has a configuration which includes a beam-receiving part 11. The beam-receiving part 11 has a function for: reflecting a beam from the laser diode 8 to an objective lens; and passing a reflected beam from the optical disc 14 to a beam splitter 12. A recording strategy adjuster 13 for controlling adjustment of a recording strategy, a record power, and a bias power is incorporated inside the system controller 6.

The beam splitter 12 reflects a beam from the laser diode (LD) 8 to the objective lens. In addition, the beam splitter 12 passes a reflected beam from the optical disc 14 to the beam-receiving part 11. The beam-receiving part 11 converts the beam into an electric signal to supply the signal to a PreAMP not shown in the drawing. The PreAMP amplifies the received electric signal and supplies the signal to a RF circuit part 4.

The RF circuit 4 calculates the PRSNR, an amplitude, and a modulation degree. A signal from the beam splitter 12 is inputted to the RF circuit 4, and is processed by the filtering, the equalizing, the PLL, and the like. In a case of using the PRML, a process such as the Viterbi decoding is carried out here. To facilitate understanding of a present invention, an exemplary embodiment described below will be explained in accordance with a case where the LD wavelength of the optical head 3 is 405 nm and the NA (numerical aperture) is 0.65.

The recording strategy adjuster 13 of the system controller 6 recognizes a correspondence between a recording condition and a signal quality on: the basis of the PRSNR sent from the RF circuit 4; and a PI error obtained from a data string demodulated by the demodulator 5 (amplitude depending on circumstances), and adjust an optimum recording strategy by controlling a series of adjustment sequence.

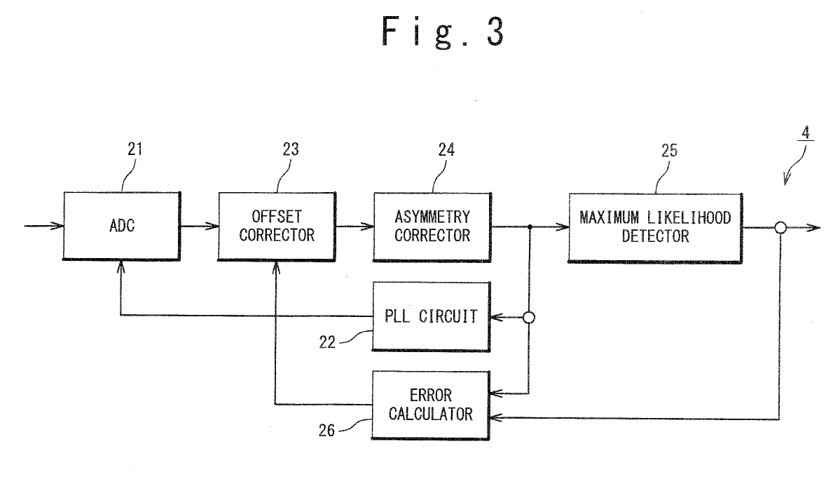

A configuration of the RF circuit 4 will be explained below. FIG. 3 is a block diagram exemplifying the configuration of the RF circuit 4 of this exemplary embodiment. Referring to FIG. 3, the RF circuit 4 is configured to include: a pre-filter not shown in the drawing; an auto gain control (AGC) not shown in the drawing; an A/D converter (ADC) 21; a phase locked loop (PLL) 22; an offset corrector 23; an asymmetry corrector 24; a maximum likelihood detector including an adaptive equalizer and a Viterbi decoder; and an error detector 26. To facilitate understanding of a present invention, an exemplary embodiment described below will be explained in accordance with a case where the RF circuit 4 has a Viterbi decoder for PR(1, 2, 2, 2, 1).

In the RF circuit 4, an adaptively-equalized signal and a Viterbi-decoded data string signal are inputted to a signal comparator, and the PRSNR is calculated by the signal comparator. A noise of each time required at the PRSNR calculation is calculated as a difference of an ideal signal waveform obtained by a convolution integral of the Viterbi-decoded data string signal and the (1, 2, 2, 2, 1) vector; and the adaptively-equalized signal (an actual signal waveform). In addition, an amplitude and a modulation degree are calculated by using a difference between the ideal signal waveform and the adaptively-equalized signal (an actual signal waveform) in the PRSNR detector.

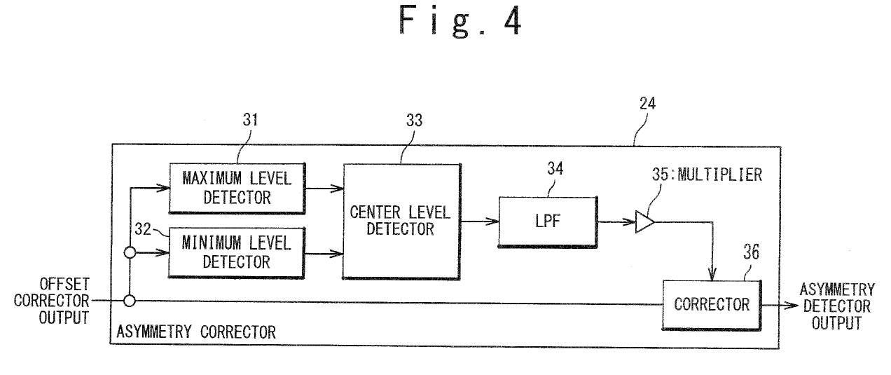

A configuration of the above-mentioned asymmetry corrector 24 will be explained below. FIG. 4 is a block diagram exemplifying the configuration of the asymmetry corrector 24. Referring to FIG. 4, the asymmetry corrector 24 is configured to include a maximum level detector 31, a minimum level detector 32, a center level detector 33, a LPF (Low-Pass Filter) 34, a multiplier 35, and a corrector 36.

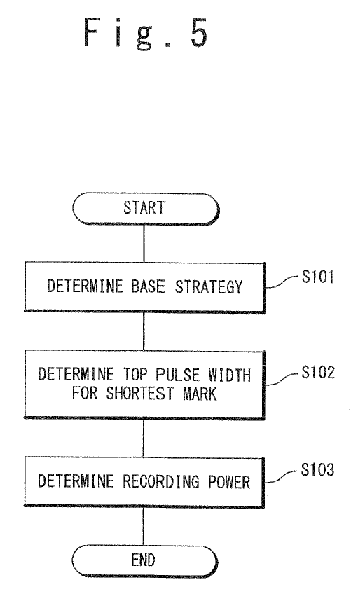

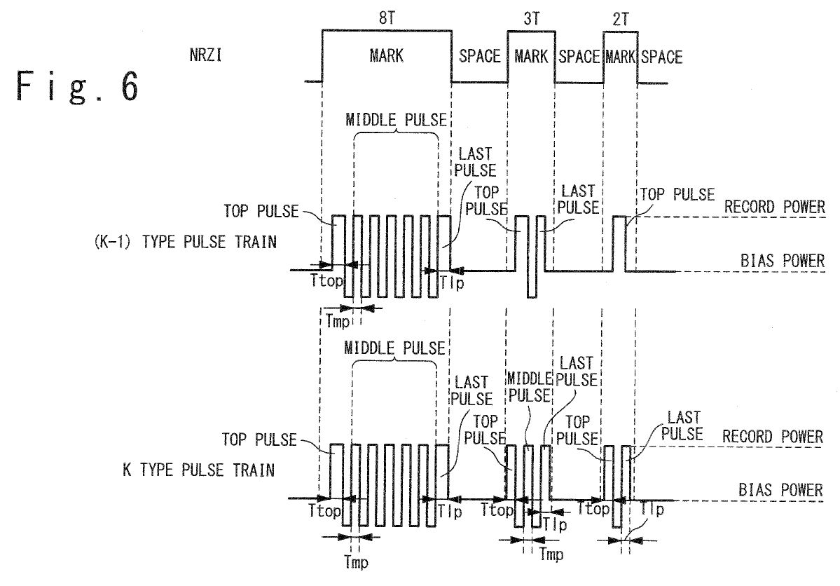

An operation of this exemplary embodiment will be explained below. Here, 2 T serves as a single pulse, and this single pulse is referred to as a top pulse. FIG. 5 is a flowchart exemplifying an operation of the information recording and reproducing device 1 according to this exemplary embodiment. In addition, FIG. 6 is a waveform chart showing waveforms of a (k)-type pulse train and a (k-1)-type pulse train. Here, in a recording strategy corresponding to a mark portion of NRZI, an upper portion of the maximum amplitude is a record power, and an amplitude portion corresponding to a space portion is a bias power. In a following exemplary embodiment, to facilitate understanding of a present invention, the operation of this exemplary embodiment will be explained in accordance with a case of employing the (k-1)-type pulse train shown in FIG. 6. Meanwhile, this does not mean that a recording strategy in a present invention is limited to the (k-1)-type pulse train. Moreover, the operation of this exemplary embodiment will be explained in relation to a case where a change of pulse width described later is realized by changing a pulse anterior edge in any pulses.

Referring to FIG. 5, when the optical disc 14 is loaded to the information recording and reproducing device 1, the operation of this exemplary embodiment starts. At step S101, a base strategy is determined. When the maximum power of a record power that can be emitted of the information recording and reproducing device 1 is 12 mW, the record power is 9.0 mW and the bias power is 3.6 mW as predetermined powers in consideration of a power margin of the medium, temporal changes, environmental changes, and the like. In addition, when this base strategy is determined, the PRML detection is carried out by applying the asymmetry corrector 24, and the PRSNR is measured on the basis of the detection result. In the determination of base strategy, all of a top pulse, a middle pulse, and a last pulse are assumed to have a same pulse width. Additionally, a basic pulse width is changed from 0.38 T to 0.86 T in step widths of 0.03 T. In this manner, the basic pulse width is obtained by using the PRSNR, and the base strategy is determined.

Next, at step S102, a top pulse width corresponding to the shortest mark is determined on the basis of the basic pulse width obtained at step S101 by using the PRSNR. Regarding the pulse width at this time, the top pulse width is determined by changing “the basic pulse+(approx. −0.06 T to +0.18 T)” in steps of approx. 0.03 T, employing the basic pulse width as a center.

At step S103, each of the record power and the bias power is determined in turn by: changing a range of approx. ±20% in steps of 5%; and using the PRSNR, employing the initially-predetermined power as a center.

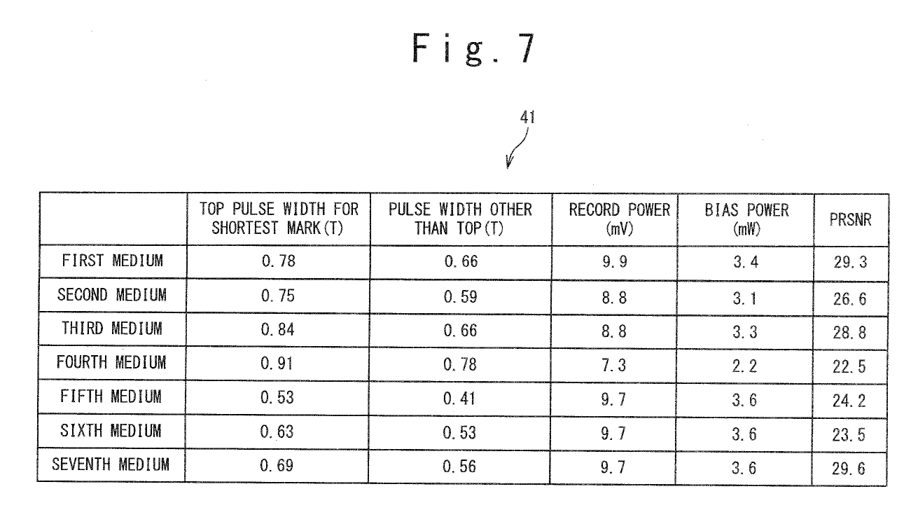

FIG. 7 is a table (hereinafter referred to as a table 41) showing adjustment results of cases of applying the operation of a first exemplary embodiment to seven types of HD DVD-R media. The table 41 of FIG. 7 shows that adjustment results showing good performance are obtained in all media from the first medium to the seventh medium. As described here, by configuring the information recording and reproducing device 1 of this exemplary embodiment and applying the recording condition adjustment method of this exemplary embodiment to the information recording and reproducing device 1, good recording conditions can be obtained at a high speed also in the HD DVD using the PRML detection.

In addition, a case where an edge to be changed is a posterior edge of pulse always in any pulses will be explained below. In this case, at step S101 of FIG. 5, the basic pulse width is obtained to determine the base strategy by: changing the basic pulse width from 0.38 to 0.86 in step widths of 0.03 T, employing the same pulse width for all of the top pulse, the middle pulse, and the last pulse; and using the PRSNR as an index of performance.

Next, at step S102, regarding the top pulse width corresponding to the shortest mark, the top pulse width is determined on the basis of the basic pulse width obtained at step S101 by changing “the basic pulse+(approx. −0.06 T to +0.18 T)” in steps of approx. 0.03 T, employing the basic pulse width as a center.

Next, at step S103, each of the record power and the bias power is determined in turn by changing a range of approx. ±20% in steps of 5%, employing a predetermined power as a center. An adjustment result of a fifth exemplary embodiment is the same as the result of FIG. 7. When an information recording and reproducing device 1 of this exemplary embodiment operates under a condition where an edge to be changed is a posterior edge of pulse always in any pulses, a good recording condition also can be obtained at a high speed in the HD DVD using the PRML detection.

### Second Exemplary Embodiment

A second exemplary embodiment of a present invention will be explained below. A configuration of the information recording and reproducing device 1 of a second exemplary embodiment is the same as that of the first exemplary embodiment. Accordingly, a detailed explanation of the configuration of the information recording and reproducing device 1 will be omitted in a second exemplary embodiment. In the information recording and reproducing device 1 of a second exemplary embodiment, an operation of the recording strategy adjuster 13 is different from that of the first exemplary embodiment.

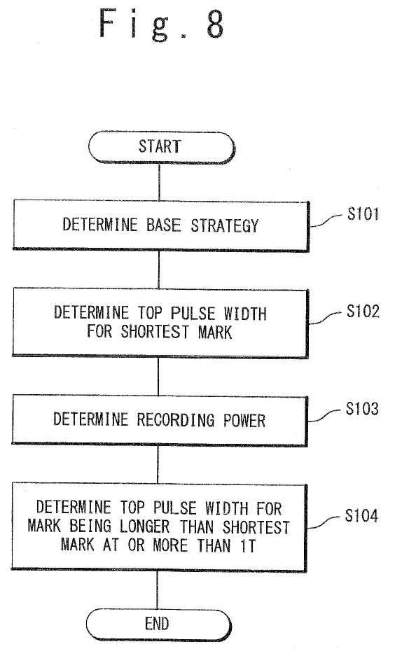

FIG. 8 is a flowchart exemplifying an operation of a second exemplary embodiment. The operation from step S101 to step S103 is the same as that of the first exemplary embodiment. Referring to FIG. 8, at step S104, a top pulse width for recording a mark of any length longer than the shortest mark by one recording unit length (1 T) or more is changed. In this manner, the top pulse width for recording a mark longer than the shortest mark is set as a second top pulse width.

Since the shortest mark has 2 T (the longest has 13 T) in a case of ETM modulation, marks having 3 T or more are included in that. In a second exemplary embodiment, an adjustment is carried out by separating 3 T and 4 T or more in separated categories, and all of the marks of 4 T or more are assumed to have a same top pulse width. Here, an adjustment order is from 3 T to 4 T or more, and the top pulse width is determined in turn in the order from the top pulse width corresponding to the mark of 3 T to the top pulse width corresponding to the mark of 4 T or more on the basis of the basic pulse width obtained at step S101. Regarding the pulse width at this time, the top pulse width is determined by changing “the basic pulse+(approx. −0.06 T to +0.18 T)” in steps of approx. 0.03 T to change an anterior edge of pulse, employing the basic pulse width as a center and employing the PRSNR as an index.

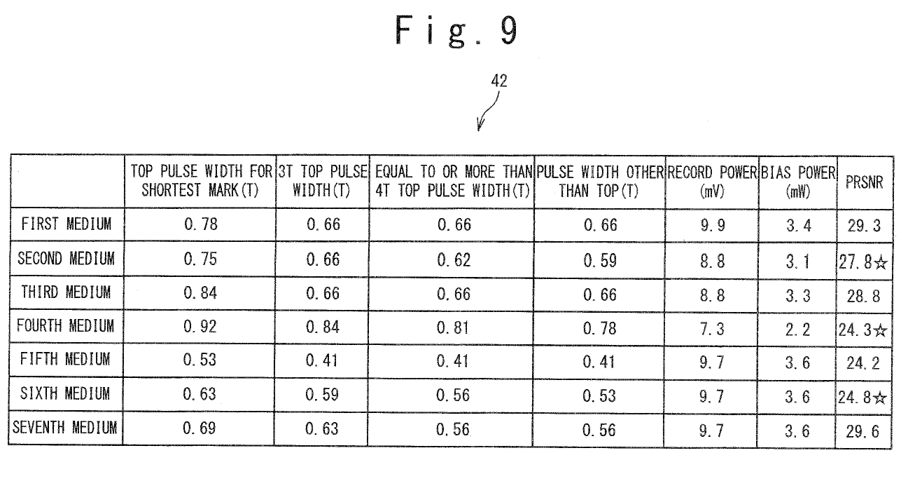

FIG. 9 is a table (hereinafter referred to as a table 42) exemplifying adjustment results obtained by inserting seven types of optical discs 14 to the information recording and reproducing device 1 and adjusting the recording conditions. As shown in table 42, in a second medium, a fourth medium, and a sixth medium, better results than that of the first exemplary embodiment (star marks are added to figures of the PRSNR of improved result) has been obtained. For the other media, results equivalent to those of the first exemplary embodiment is obtained. That is, when the operation of a second exemplary embodiment is carried out, better results than those of the first exemplary embodiment can be obtained by a certain medium. In a case where the information recording and reproducing device 1 operates after specifying the medium, a better result can be obtained by carrying out the adjustment method shown in the second exemplary embodiment. It is preferred to determine at a design phase on the basis of balance between a restriction of time required for the adjustment and adjustment accuracy whether the first exemplary embodiment or the second exemplary embodiment should be carried out. In addition, an adjustment order of categories of 3 T and 4 T or more at step S104 can be exchanged. Moreover, it is also possible not to carry out an adjustment of either one of the categories of 3 T and 4 T or more at step S104. Furthermore, it is possible to carry out the adjustment after further subdividing the category of 4 T or more at step S104. It is preferred to determine these at a design phase on the basis of balance between a restriction of time required for the adjustment and adjustment accuracy.

### Third Exemplary Embodiment

A third exemplary embodiment of a present invention will be explained below. A configuration of the information recording and reproducing device 1 of a third exemplary embodiment is the same as that of the first exemplary embodiment. Accordingly, a detailed explanation of the configuration of the information recording and reproducing device 1 will be omitted in a third exemplary embodiment. In the information recording and reproducing device 1 of a third exemplary embodiment, an operation of the recording strategy adjuster 13 is different from that of the first exemplary embodiment. In a third exemplary embodiment, the recording strategy adjuster 13 sets a width of last pulse for recording a mark.

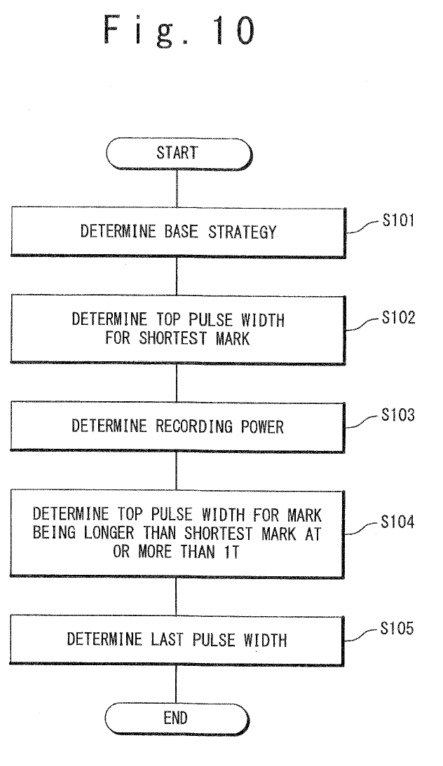

FIG. 10 is a flowchart exemplifying an operation of a third exemplary embodiment. As shown in FIG. 10, the operation from step S101 to step S104 is the same as that of the second exemplary embodiment.

At step S105, among the last pulses for mark formation on the information recording medium, a width of last pulse for recording a mark of any length longer than the shortest mark by one recording unit length (1 T) or more is changed. In this manner, the width of last pulse for recording a mark is appropriately set. Meanwhile, in the case of the (k-1)-type pulse train, 2 T includes only the top pulse. Accordingly, an edge opposite to the edge of pulse used for the adjustment at step S102 may be adjusted at this step S105.

In a third exemplary embodiment, as the order of adjustment, a posterior end of the shortest mark is adjusted, a posterior end of the last pulse of 3 T is adjusted, and then a posterior end of the last pulse of 4 T or more is adjusted. In addition, similar to the second exemplary embodiment, an adjustment in a third exemplary embodiment is carried out by separating 3 T and 4 T or more in separated categories. Here, all of the marks of 4 T or more are assumed to have a same last pulse width. In the adjustment in a third exemplary embodiment, the last pulse width is determined in turn in the order from the last pulse widths corresponding to 2 T mark and 3 T mark to the last pulse width corresponding to 4 T or more on the basis of the basic pulse width obtained at step S101. Regarding the pulse width at this time, the last pulse width is determined by changing “the basic pulse+(approx. −0.16 T to +0.18 T)” in steps of approx. 0.03 T, employing the basic pulse width as a center Meanwhile, in the case of the (k)-type pulse train, the width of last pulse is employed also in 2 T, and when the width is applied to this exemplary embodiment, a posterior end of last pulse is adjusted.

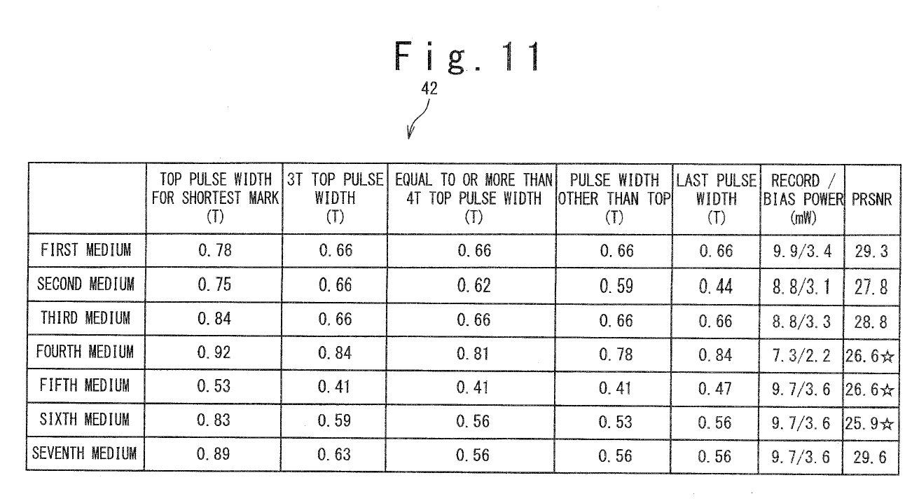

FIG. 11 is a table (hereinafter referred to as a table 43) exemplifying adjustment results obtained by inserting different types of seven optical discs 14 to the information recording and reproducing device 1 and adjusting recording conditions. As shown in table 43, in a fourth medium and a fifth medium and a sixth medium, better results than those of the first and second exemplary embodiments (star marks are added to figures of the PRSNR of improved results) has been obtained. In the other media, results equivalent to those of the first exemplary embodiment and the second exemplary embodiments are obtained.

Improvement of the fifth medium cannot be obtained in the second exemplary embodiment. However, referring to FIG. 11, in an adjustment to the fifth medium, an adjustment performance of the information recording and reproducing device 1 is improved by carrying out the adjustment of the last pulse according to the third exemplary embodiment, thereby a good adjustment result can be obtained. Accordingly, for certain media, a good result can be obtained by carrying out the adjustment method corresponding to the third exemplary embodiment.

The device may be configured so as to selectively determine as to which one of the first to third exemplary embodiments is carried out on the basis of balance between a restriction of time required for the adjustment and an adjustment accuracy. In addition, it may be determined at a design phase which one of the first to third exemplary embodiments is carried out. The third exemplary embodiment can be carried out when the adjustment order at step S105 is changed. Moreover, it is also possible not to carry out an adjustment of either one of the adjustments of: the posterior end of last pulse of 3 T; and the posterior end of last pulse of 4 T or more. Furthermore, it is also possible to carry out the adjustment after further subdividing the category of 4 T or more. Additionally, the process shown at step S105 may be carried out prior to the operation at step S104 or before. And further, Step S105 may be carried out after the process at step S103 without carrying out the process at step S104. It is preferred that the information recording and reproducing device 1 is configured so as to selectively carry out these operations on the basis of balance between a restriction of time required for the adjustment and an adjustment accuracy. In addition, in the information recording and reproducing device 1, these operations may be determined at a design phase on the basis of balance between a restriction of time required for the adjustment and an adjustment accuracy.

### Fourth Exemplary Embodiment

A fourth exemplary embodiment of a present invention will be explained below. A configuration of the information recording and reproducing device 1 of a fourth exemplary embodiment is the same as that of the first exemplary embodiment. Accordingly, a detailed explanation of the configuration of the information recording and reproducing device 1 will be omitted in a fourth exemplary embodiment. In a fourth exemplary embodiment, an operation of the recording strategy adjuster 13 is different from that of the first exemplary embodiment. The information recording and reproducing device 1 of a fourth exemplary embodiment includes a power allowance judgment function for judging whether or not a recording power has been adjusted to be a power or less that can be emitted by the information recording and reproducing device 1. The information recording and reproducing device 1 judges whether or not the recording power has been adjusted to be a power or less that can be emitted. As a result of the judgment, in a case where the recording power is near an emission limit, the adjustment at step S106 described later is carried out immediately before an end of the adjustment.

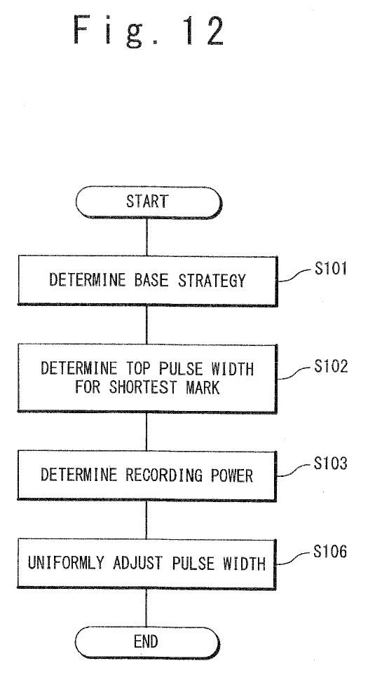

FIG. 12 is a flowchart exemplifying an operation of the fourth exemplary embodiment. As shown in FIG. 12, the operation from step S101 to step S103 is the same as the operation of the first exemplary embodiment. At step S106, the information recording and reproducing device 1 carries out an operation (an all pulse widths uniform adjustment step) for increasing and changing the record power and the pulse widths of all pulses uniformly at constant magnification, using a relationship shown in a table 44 described later.

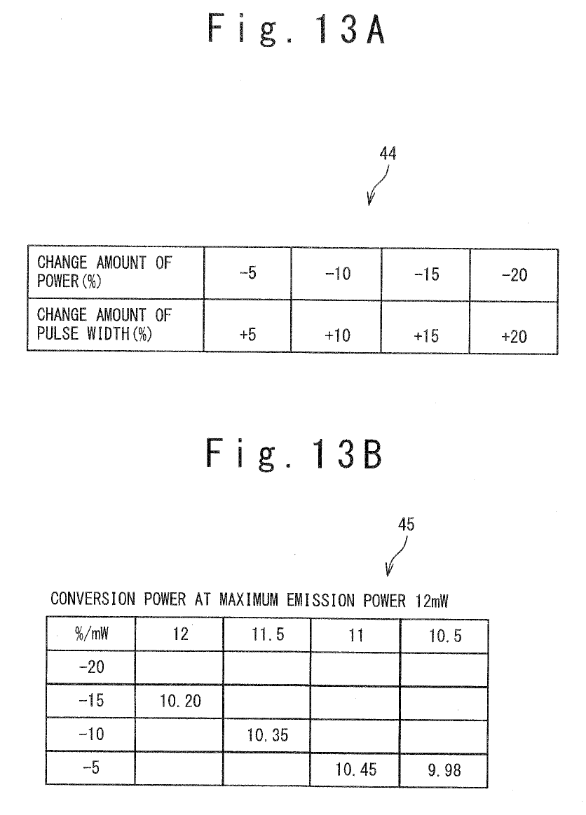

FIG. 13(a) is a table (hereinafter referred to as the table 44) referred to in a process carried out at the all pulse widths uniform adjustment step. The table 44 exemplifies a correspondence relationship between a record power and an amount of change of pulse width. For example, in a device having the maximum emission limit of 12 mW, when a power margin of at least ±10% is secured, an allowable value is 10.8 mW. In a case of a record power exceeding this, step S106 is carried out on the basis of the table 44. Meanwhile, a reduction rate of record power is obtained by the following expression (1).

(Obtained record power)×Reduction rate≦10.8 mW (in the maximum emission of 12 mW) (1)

In a case where a record power is 11 mW when an optical disc 14 is inserted into the information recording and reproducing device 1 and a recording condition is adjusted, the record power exceeds 10.8 mW that is the record power of an allowable value. Accordingly, the information recording and reproducing device 1 executes recording and a reproducing at an adjusted value obtained by reducing the record power of 11 mW by 5% and increasing a conversion magnification of pulse width by 5%, using the table 44 and without changing the bias power.

As a result obtained by measuring the execution result regarding the PRSNR, the PRSNR is approximately 24. Meanwhile, in a case expression (1) is not satisfied, the reduction rate is reduced by 5, 10, 15, and 20 in turn (refer to the table 45 of FIG. 13(b)). By carrying out the operation at S106, the recording power can be totally adjusted more appropriately.

### Fifth Exemplary Embodiment

A fifth exemplary embodiment of a present invention will be explained below. A configuration of the information recording and reproducing device 1 in a fifth exemplary embodiment is the same as that of the first exemplary embodiment. Accordingly, a detailed explanation of the configuration of the information recording and reproducing device 1 will be omitted in a fifth exemplary embodiment. Additionally, in a fifth exemplary embodiment, an operation of a case where the target optical disc 14 has a system information area and “Disc Manufacturing information” including information such as a disc maker name and a manufacturing area is retained will be exemplified. In this case, when an optical disc 14 is inserted, the optical head 3 of the information recording and reproducing device 1 moves to the system information region of the disc. The optical head 3 obtains a type of the disc, a disc maker name, and the like from the system information region on the basis of the “Disc Manufacturing information” including information such as the disc maker name and a manufacturing area. The information recording and reproducing device 1 determines the inserted optical disc 14 as a medium A on the basis of the obtained information.

The information recording and reproducing device 1 of a fifth exemplary embodiment is different from that of the first exemplary embodiment in an operation of the recording strategy adjuster 13. Specifically, at step S102, a width obtained by multiplying a coefficient preliminarily determined as a top pulse width corresponding to the shortest mark by the basic pulse width is set as a top pulse width. Then, the top pulse widths of 2 T, 3 T, and 4 T or more corresponding to the basic pulse width, corresponding information of the last pulse width, and a performance obtained by preliminarily matching performances in a drive device (supposed PRSNR) are obtained.

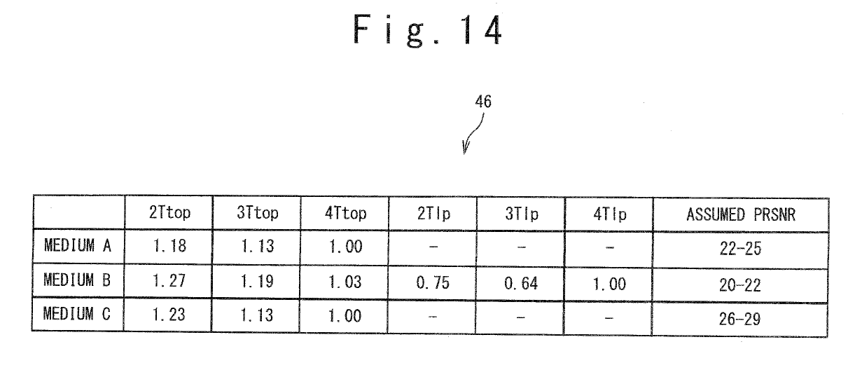

FIG. 14 is a table (hereinafter referred to as a table 46) exemplifying a configuration of the obtained information. The table 46 relates the top pulse widths of 2 T, 3 T, and 4 T or more corresponding to the basic pulse width, the corresponding information of the last pulse width, and the performance obtained by preliminarily matching performances in a drive device (supposed PRSNR) each described above with each other and retain them.

After determining the inserted optical disc 14 as the medium A, the information recording and reproducing device 1 obtains the table 46. After that, the information recording and reproducing device 1 carries out the adjustment in accordance with the recording adjustment method shown in FIG. 5. At step S101, a base strategy is determined. After that, at step S102, a top pulse width corresponding to the shortest mark is set by multiplying the basic pulse width by a preliminarily determined coefficient, using a correspondence relationship shown in the table 46 of FIG. 14. Then, at step S103, the recording power is adjusted.

The PRSNR of a case where a region of the above-mentioned medium A to which the adjustment of the fifth exemplary embodiment is completed is reproduced is 22.5. Referring to FIG. 14, this value is near the performance (supposed performance) obtained by preliminarily matching performances in a drive device. In the information recording and reproducing device 1 of this exemplary embodiment, a good recording condition can be obtained at a high speed also in the HD DVD using the PRSNR detection by carrying out the operation of the fifth exemplary embodiment. In addition, as shown in FIG. 14, in a case of a medium B different from the medium A, 2 Tlp that is the last pulse of 2 T is set. This is a setting of the case of assuming the (k)-type pulse train.

Additionally, the top pulse width is set at step S102, however, a top pulse width other than 2 T may be set independently or simultaneously as the top pulse width setting. Moreover, in a case where the supposed PRSNR is not satisfied, a top pulse width other than 2 T may be set independently in turn or simultaneously. Furthermore, in the case where the supposed PRSNR is not satisfied, step S102 may be searched again as shown in the first exemplary embodiment.

In addition, compared to the first exemplary embodiment, the case of the first exemplary embodiment is a method efficient in that: the recording strategy can be adjusted even when a medium that was not appeared at shipment of drive is used for the drive device; and the method has a high accuracy and can be widely used. This exemplary embodiment is preferred to be applied to a medium to which parameters are preliminarily matched. Even in a case of a medium whose information is not retained by a drive, the adjustment can be simply carried out.

### Sixth Exemplary Embodiment

A sixth exemplary embodiment of a present invention will be explained below. A configuration of the information recording and reproducing device 1 in a sixth exemplary embodiment is the same as that of the first exemplary embodiment. Accordingly, a detailed explanation of the configuration of the information recording and reproducing device 1 will be omitted in a sixth exemplary embodiment. Unlike the first exemplary embodiment, a sixth exemplary embodiment carries out an adjustment by using an overall amplitude of a reproduction signal including marks having various lengths and spaces as a performance index for the determination of the base strategy at step S101. Meanwhile, when a pulse width is changed, an anterior edge of the pulse width is assumed to be changed in any pulses. In addition, the following explanation is given corresponding to a case where the optical disc 14 to be adjusted (for example, HD DVD) is the second medium shown in FIG. 7.

The operation of a sixth exemplary embodiment starts when the optical disc 14 is set to the information recording and reproducing device 1. At step S101, the maximum power of a record power that can be emitted of the information recording and reproducing device 1 is 12 mW, the record power is 9.0 mW and the bias power is 3.6 mW as predetermined powers in consideration of an average power margin of many media used for study, temporal changes, environmental changes, and the like.

In addition, the record power and the bias power are fixed, and the basic pulse width is determined, employing the same pulse width for all of the top pulse, the middle pulse, and the last pulse. On this occasion, the basic pulse width is obtained by: changing the basic pulse width from 0.38 T to 0.86 T in step widths of 0.03 T; and using the all over amplitude to determine the base strategy. In this case, it is supposed that a pulse width where a change rate of peak value of amplitude of a maximum mark space length is approximately constant to a pulse width increase is selected. In a sixth exemplary embodiment, a result showing the basic pulse width is 0.59 T is obtained as a result of carrying out the process at step S101 to the optical disc 14.

Next, at step S102, atop pulse width corresponding to the shortest mark is determined on the basis of the basic pulse width of 0.59 T obtained at S101 by using the PRSNR. Regarding the pulse width at this time, the top pulse width is determined by changing “the basic pulse+(approx. −0.06 T to +0.18 T)” in steps of approx. 0.03 T, employing the basic pulse width as a center. In a sixth exemplary embodiment, the 2 T top pulse width is obtained as 0.75 T as a result of carrying out the process at step S102 to the optical disc 14.

Next, at step S103, each of the record power and the bias power is changed within approx. ±20% in steps of 5%, employing an initially-predetermined power as a center, and powers are determined in turn by using the PRSNR. In a sixth exemplary embodiment, as the result of carrying out the process at step S103 to the optical disc 14, the PRSNR is approximately 27 as a final performance. This is the same result as that of the second medium in FIG. 7. In the information recording and reproducing device 1 of this exemplary embodiment, a good recording condition can be obtained at a high speed also in the HD DVD using the PRSNR detection by carrying out the operation of a sixth exemplary embodiment.

### Seventh Exemplary Embodiment

A seventh exemplary embodiment of a present invention will be explained below. A configuration of the information recording and reproducing device 1 in a seventh exemplary embodiment is the same as that of the first exemplary embodiment. Accordingly, a detailed explanation of the configuration of the information recording and reproducing device 1 will be omitted in a seventh exemplary embodiment. Additionally, in a seventh exemplary embodiment, the following explanation is given corresponding to a case where the optical disc 14 to be adjusted (for example, HD DVD) is a seventh medium shown in FIG. 7.

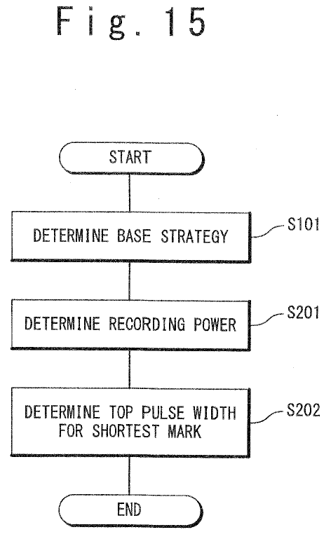

FIG. 15 is a flowchart exemplifying an operation of a seventh exemplary embodiment. Referring to FIG. 15, the operation of a seventh exemplary embodiment carries out each step of: the base strategy determination (step S101); the recoding power determination (step S201), and the shortest mark top pulse width determination (step S202) in turn. Meanwhile, when a pulse width is changed, an anterior edge of the pulse width is assumed to be changed in any pulses.

At step S101, when the maximum power of a record power that can be emitted of the information recording and reproducing device 1 is 12 mW, the record power is 7.0 mW and the bias power is 3.0 mW as predetermined powers in consideration of a power margin of the optical disc 14, temporal changes, environmental changes, and additionally an temperature increase. In addition, the basic pulse width is obtained by: changing the basic pulse width from 0.38 T to 0.86 T in step widths of 0.03 T; and using the PRSNR, employing the same pulse width for all of the top pulse, the middle pulse, and the last pulse with the record power and the bias power fixed, and the base strategy is determined. On this occasion, in a case where a basic pulse width showing the best cannot be determined, the record power is 7.7 mW by increasing at 10%. Then, a step width is set to be wider than before (for example, 0.06 T), and a provisional basic pulse width is obtained by using the PRSNR. On that basis, the basic pulse width is finally determined by using the PRSNR through the recording and reproducing at a pulse width of ±0.03 T, employing a pulse width showing the best PRSNR as a center.

Next, each of the record power and the bias power is changed within approx. ±20% in steps of 5%, employing an initially-predetermined power as a center, and powers are determined in turn by using the PRSNR (step S201). Then, a top pulse width corresponding to the shortest mark is determined on the basis of the basic pulse width obtained at step S101 by using the PRSNR. Regarding the pulse width at this time, the top pulse width is determined by changing “the basic pulse+(approx. −0.06 T to +0.18 T)” in steps of approx. 0.03 T, employing the basic pulse width as a center.

In a seventh exemplary embodiment, the base strategy can be certainly determined by appropriately changing a way to set the power and the pulse width depending on the situation. As a result of the adjustment, the PRSNR is approximately 29 and a performance nearly equal to a seventh medium of FIG. 7 can be achieved. Accordingly, by employing the recording condition adjustment method and the information recording and reproducing device 1 of a present invention, a good recording condition can be obtained at a high speed also in the HD DVD using the PRML detection.

### Eighth Exemplary Embodiment

An eighth exemplary embodiment of a present invention will be explained below A configuration of the information recording and reproducing device 1 in an eighth exemplary embodiment is the same as that of the first exemplary embodiment. Accordingly, a detailed explanation of the configuration of the information recording and reproducing device 1 will be omitted in an eighth exemplary embodiment Additionally, in an eighth exemplary embodiment, the following explanation is given corresponding to a case where the optical disc 14 to be adjusted (for example, HD DVD) in the second medium shown in FIG. 7.

Unlike the first exemplary embodiment, an eighth exemplary embodiment carries out the selection of base strategy by: fixing a bias power to be a predetermined power with a pulse width constant; and changing a record power.

An eighth exemplary embodiment will be explained in response to a case where a maximum power of a record power that can be emitted of the information recording and reproducing device 1 is 12 mW. In consideration of a power margin of the optical disc 14, temporal changes, environmental changes, and the like, the record power as predetermined powers is changed within approx. ±20% in steps of 5%, employing 9.0 mW as a center. In addition, the bias power is fixed to 3.6 mW. All of the top pulse, the middle pulse, and the last pulse are set to 0.59 T (the same pulse width), and the base strategy is determined by using the PRSNR. Meanwhile, the pulse width set here is preliminarily studied, however, the pulse width may be an average value in a device to be used and a plurality of media. In an eighth exemplary embodiment, it has been found as a result that the best record power is 9.4 mW in the case where the maximum power is 12 mW.

Next, at step S102, the top pulse width corresponding to the shortest mark is determined on the basis of the basic pulse width by using the PRSNR. Regarding the pulse width at this time, the top pulse width is determined by changing “the basic pulse+(approx. −0.06 T to +0.18 T)” in steps of approx. 0.03 T at an anterior edge of pulse, employing the basic pulse width as a center. In a case where the obtained record power is 9.4 mW, the bias power is 3.6 mW, the basic pulse width is 0.59 T, 2 T top pulse width is determined to be 0.75 T as a result.

Next, at step S103, each of the record power and the bias power is changed within approx. ±10% in steps of 36, employing an initially-predetermined power as a center, and powers are determined in turn by using the PRSNR. The final performance of the PRSNR is approximately 27. This is nearly equal to the result of the second medium in FIG. 7. Accordingly, by employing the recording condition adjustment method and the information recording and reproducing device 1 of a present invention, a good recording condition can be obtained at a high speed also in the HD DVD using the PRML detection.

### Ninth Exemplary Embodiment

A ninth exemplary embodiment of a present invention will be explained below. A configuration of the information recording and reproducing device 1 in a ninth exemplary embodiment is the same as that of the first exemplary embodiment. Accordingly, a detailed explanation of the configuration of the information recording and reproducing device 1 will be omitted. In a ninth exemplary embodiment, the adjustment is carried out in a procedure similar to that of the third exemplary embodiment. Here, unlike the third exemplary embodiment, the adjustment is carried put by using the (k)-type pulse train in a ninth exemplary embodiment. In addition, an anterior edge of pulse is changed in the adjustment of the top pulse, and a posterior edge of pulse is changed in the adjustment of the last pulse.

In a ninth exemplary embodiment, each of steps S104 and S105 of the procedure shown in FIG. 10 does not overlap. And, the adjustment is carried out in the order of 2 T, 3 T, and 4 T or more, a parameter determined in each adjustment is applied to the following adjustment, and the parameters are sequentially determined.

At step S101, when a maximum power of a record power that can be emitted of the information recording and reproducing device 1 is 12 mW, the record power is 9.0 mW and the bias power is 3.6 mW as predetermined powers in consideration of a power margin of the optical disc 14, temporal changes, environmental changes, and the like. The PRML detection is carried out in determining this base strategy by employing the asymmetry corrector 24, and the PRSNR is measured. In the determination of base strategy, a basic pulse width is obtained by changing the basic pulse width from 0.38 T to 0.86 T in step widths of 0.03 T; and using the PRSNR, employing the same pulse width for all of the top pulse, the middle pulse, and the last pulse, and the base strategy is determined.

Next, the top pulse width corresponding to the shortest mark is determined on the basis of the basic pulse width obtained at step S101 by using the PRSNR. Regarding the pulse width at this time, the top pulse width is determined by changing “the basic pulse+(approx. −0.06 T to +0.18 T)” in steps of approx. 0.03 T, employing the basic pulse width as a center.

Next, each of the record power and the bias power is changed within approx. ±20% in steps of 5%, employing an initially-predetermined power as a center, and powers are determined in turn by using the PRSNR (step S103). At step S104, an adjustment is carried out by separating 3 T and 4 T or more in separated categories, and all of the marks of 4 T or more are assumed to have the same top pulse. The top pulse width is determined in turn in the order from the top pulse width corresponding to the mark of 3 T to the top pulse width corresponding to the mark of 4 T or more on the basis of the basic pulse width obtained as step S101. Regarding the pulse width at this time, the top pulse width is determined by changing “the basic pulse+(approx. −0.06 T to +0.18 T)” in steps of approx. 0.03 T to change an anterior edge of pulse, employing the basic pulse width as a center and employing the PRSNR as an index.

At step S105, an adjustment is carried out by separating 2 T, 3 T, and 4 T or more in separated categories, and all of the last pulse widths of 4 T or more are assumed to have the same top pulse. In the adjustment, the top pulse widths are determined in turn in the order from the last pulse width corresponding to the mark of 2 T, the last pulse width corresponding to the mark of 3 T, and the last pulse width corresponding to the mark of 4 T or more on the basis of the basic pulse width obtained as step S101. Regarding the pulse width at this time, the last pulse width is determined by changing “the basic pulse+(approx. −0.06 T to +0.18 T)” in steps of approx. 0.03 T to change an posterior edge of pulse, employing the basic pulse width as a center.

A performance under the final recording condition is approximately 22 in the PRSNR, and also in the case of using the (k)-type pulse train, a good recording condition can be obtained at a high speed also in the HD DVD using the PRML detection by employing the recording condition adjustment method and the information recording and reproducing device 1 of a present invention.

### Tenth Exemplary Embodiment

A tenth exemplary embodiment of a present invention will be explained below. A configuration of the information recording and reproducing device 1 in a tenth exemplary embodiment is the same as that of the first exemplary embodiment. Accordingly, a detailed explanation of the configuration of the information recording and reproducing device 1 will be omitted. In a tenth exemplary embodiment, the adjustment is carried out in a procedure similar to that of the ninth exemplary embodiment.

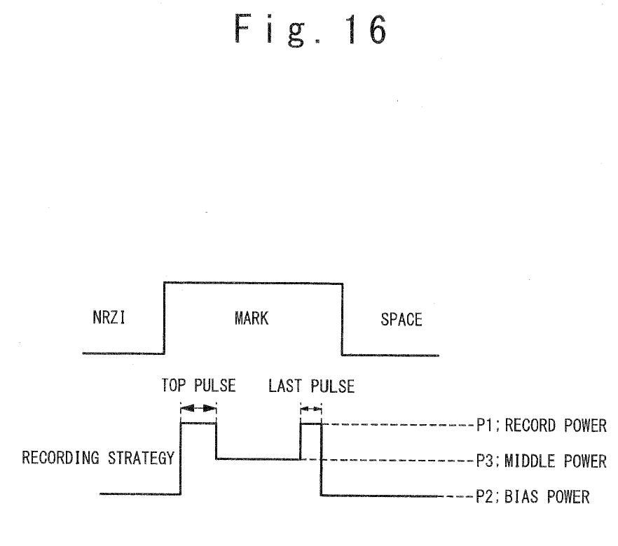

Unlike the ninth exemplary embodiment, a tenth exemplary embodiment employs not only a multi-pulse but also a non multi-pulse (a strategy based on a rectangular shape) as a recording strategy. FIG. 16 is a waveform chart exemplifying a non multi-waveform where a pulse train portion is constant in a multi-pulse waveform and a role taken by a multi-pulse portion is substituted by a power. In a tenth exemplary embodiment described below, the explanation will be carried out in response to the (k-1)-type non multi-pulse. Additionally, in a tenth exemplary embodiment, an anterior edge of pulse is changed in the adjustment of the top pulse, and a posterior edge of pulse is changed in the adjustment of the last pulse.

In the tenth exemplary embodiment, similar to the procedure of FIG. 10 referenced in the above-mentioned ninth embodiment, steps of: the base strategy determination (step S101); the shortest mark top pulse width determination (step S102); the recoding power determination (step S103); the top pulse width determination step for a mark longer than the shortest mark by 1 T or more (step S104); and the last pulse width determination step (step S105) are carried out in turn. Supposing that overlapping adjustment using the same adjustment edge is not carried out at each of steps S104 and S105, the adjustment is carried out in the order of 2 T, 3 T, and 4 T or more, a parameter determined in each adjustment is applied to the following adjustment, and the parameters are sequentially determined.

At step S101, the maximum power of a record power that can be emitted of the information recording and reproducing device 1 is 12 mW, the record power P1 is 9.0 mW and the bias power P2 is 3.6 mW as predetermined powers in consideration of a power margin of many media used for study, temporal changes, environmental changes, and the like, a basic pulse width of 0.59 T obtained in many average media is set as the top pulse width and the last pulse width, a range of ±20% is changed in steps of 5%, employing the middle power P3 of 4.5 mW as a center that is approximately half of the record power P1=9.0 mW, and the middle power is selected to determined a base strategy. The PRML detection is carried out by employing the asymmetry corrector 24 only in determining this base strategy, and the PRSNR is measured. The middle power of 5.2 mW has been obtained.

Next, the top pulse width corresponding to the shortest mark is determined by using the PRSNR on the basis of the P1 of 9.0 mW as a predetermined power, the middle power P3 of 5.2 mW obtained at step S101, and the basic pulse width of 0.59 T. Regarding the pulse width at this time, the top pulse width is determined by changing “the basic pulse+(approx. −0.06 T to +0.18 T)” in steps of approx. 0.03 T, employing the basic pulse width as a center (step S102).

And next, each of the record power and the bias power is changed within approx. ±20% in steps of 5%, keeping the ratio centered in the middle power obtained as the predetermined power P1=9.0 mW, and powers are determined in turn by using the PRSNR (step S103).

At step S104, an adjustment is carried out by separating 3 T and 4 T or more in separated categories, and all of the marks of 4 T or more are assumed to have the same top pulse. Here, the top pulse width is determined in turn in the order from the top pulse width corresponding to the mark of 3 T to the top pulse width corresponding to the mark of 4 T or more on the basis of the basic pulse width obtained as step S101. Regarding the pulse width at this time, the top pulse width is determined by changing “the basic pulse+(approx. −0.06 T to +0.18 T)” in steps of approx. 0.03 T to change an anterior edge of pulse, employing the basic pulse width as a center and employing the PRSNR as an index.

At step S105, an adjustment is carried out by separating 2 T, 3 T, and 4 T or more in separated categories, and all of the last pulse widths of 4 T or more are assumed to have a same pulse width. In the adjustment, the top pulse widths are determined in turn in the order from the last pulse width corresponding to the mark of 2 T, the last pulse width corresponding to the mark of 3 T, and the last pulse width corresponding to the mark of 4 T or more on the basis of the basic pulse width obtained as step S101. Regarding the pulse width at this time, the last pulse width is determined by changing “the basic pulse+(approx. −0.06 T to +0.18 T)” in steps of approx. 0.03 T to change a posterior edge of pulse, employing the basic pulse width as a center.

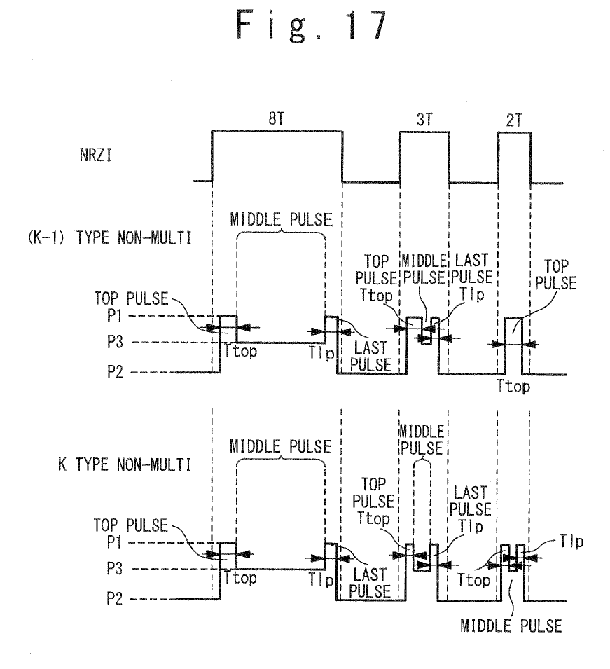

In the case of a tenth exemplary embodiment, a frame is determined by not the multi-pulse but the Pm (middle power; P3 in the rectangle of FIG. 16). Accordingly, the adjustment equivalent to those of the above-mentioned exemplary embodiments is carried out by controlling the Pm in the similar manner instead of the multi-pulse. A performance under a final recording condition is approximately 22 in the PRSNR. FIG. 17 is a waveform chart exemplifying the (k-1)-type non multi-waveform and the (k)-type non multi-waveform. When the (k)-type non multi-waveform is employed, a good recording condition can be obtained at a high speed also in the HD DVD using the PRML detection by adjusting details after the adjustment of frame that is essential.

In a plurality of the above-mentioned exemplary embodiments, the explanations have been given in response to the case where the LD wavelength of the optical head 3 is 405 nm and the NA (numerical aperture) is 0.65. The present invention is not restricted to these values, and can be applied to various wavelengths and the various NAs. In addition, a class called PR(12221) is used in the above-mentioned exemplary embodiments, however, when another class such as PR(1221) is used, a present invention can be applied. Moreover, in the above-mentioned exemplary embodiments, it is supposed that the ETM employed in the HD DVD is used as a modulation code, however, when another modulation code is used, a present invention can be applied. In that case, a shortest data length of, for example, kT (k is a natural number of 3 or more) may be changed. Furthermore, the HD DVD is used in the above-mentioned exemplary embodiments, however, the Blu-ray Disc (BD disc) can be used.

### Comparative Example

As shown in a plurality of above-mentioned exemplary embodiments, the record power and the pulse width are parameters that influence each other. Accordingly, when the adjustment starts with either one of them randomly fixed, the adjustment may easily fall into a local minimum (a local optimum). For this reason, in a plurality of the above-mentioned exemplary embodiments, the recording strategy adjustment is carried out by classifying the recording strategy into three categories of the record power, the multi-pulse width (a representative of a long mark), and the top pulse width accepting the shortest mark. Here, the multi-pulse shows a pulse other than the top pulse. In the case of a longer mark, almost of the marks are formed of the multi-pulse. When the multi-pulse width is selected as a category, the recording strategy adjustment can be carried out to the mark having longer multi-pulse width as a representative value.

An adjustment result of a case where the adjustment is carried out by changing the order of each category when the adjustment is carried out by classifying the recording strategy into three categories will be explained below as a comparative example. In the present comparative example, the adjustment is carried out by using the above-mentioned information recording and reproducing device 1. In addition, the write once optical disc 14 (for example, the HD DVD-R) that is recordable once is used as the information recording medium. The optical disc 14 is a type of medium that uses organic coloring material accepting a short wavelength to a recording layer and that increases reflectivity after a recording, and is a type of optical disc 14 called a Low-to-High medium. As a physical structure of the disc, a guide groove called a pregroove is formed on a discoidal transparent substrate having a thickness of 0.6 mm and a diameter of 12 cm, the substrate being made of polycarbonate, and in recording and reproducing information, laser light of the information recording and reproducing device 1 (an optical disc drive) can scan the disc along this guide groove. A film for the recording is formed on this substrate. As a physical format, an in-groove format having a bit pitch of 0.15 μm and a track pitch of 0.40 μm is used.

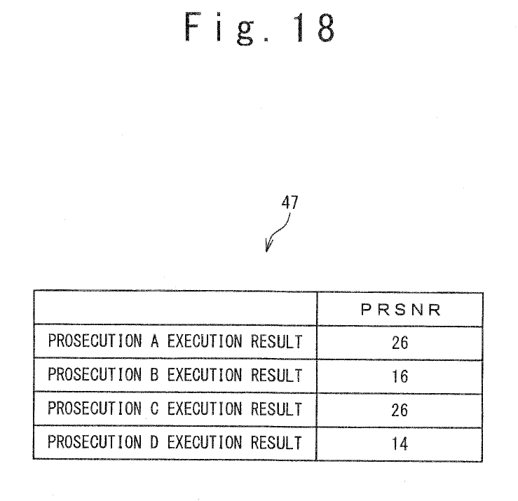

FIG. 18 is a table (hereinafter referred to as a table 47) exemplifying an adjustment result obtained when the order of each category is changed The table 47 of FIG. 18 shows an adjustment result of the case where the recording strategy adjustment is executed in response to the following 4 sequences.

A procedure A execution result shows an execution result of the recording strategy adjustment of a case where “record power fixation multi-pulse width search the shortest mark correspondence top pulse width search” is the procedure A. A procedure B execution result shows an execution result of the recording strategy adjustment of a case where “record power fixation the shortest mark correspondence top pulse width search multi-pulse width search” is the procedure B. A procedure C execution result shows an execution result of the recording strategy adjustment of a case where “multi-pulse width fixation record power search the shortest mark correspondence top pulse width search” is the procedure C. A procedure D execution result shows an execution result of the recording strategy adjustment of a case where “multi-pulse width fixation the shortest mark correspondence top pulse width search record power search” is the procedure D.

In addition, the (k-1)-type pulse train is used as a condition for obtaining the execution result shown in FIG. 18. Moreover, a parameter obtained when a recording and a reproducing are tested by changing the parameter (the pulse width or the record power) in a stepwise fashion and the recording provides the best reproducing performance is selected for the search. Furthermore, the selected parameter is used for the subsequent search.

Referring to FIG. 18, though the procedure A and the procedure C show superior performances, the procedure B and the procedure D show inferior performances. Thus, it can be understood that adjustments of the multi-pulse width and the record power are interchangeable and that the top pulse is hard to be adjusted when the multi-pulse width and the record power have not been determined.

A fact that a combination of the multi-pulse and the record power has to be firstly adjusted means that an overview of the recording marks, namely, a frame has to be firstly determined. In other words, it can be said that sizes of recording marks with various lengths are determined by the combination of the multi-pulse and the record power. On the contrary, when the combination is inappropriate, the adjustment may fall into a local minimum. In addition, the top pulse of the shortest mark is an important parameter that influences a recording and reproducing performance. However, based on a viewpoint of the recording strategy adjustment, the top pulse of the shortest mark is a somewhat attendant element. At the same time, regarding the marks with various lengths, the top pulse is a somewhat attendant element from a viewpoint of the recording strategy adjustment.

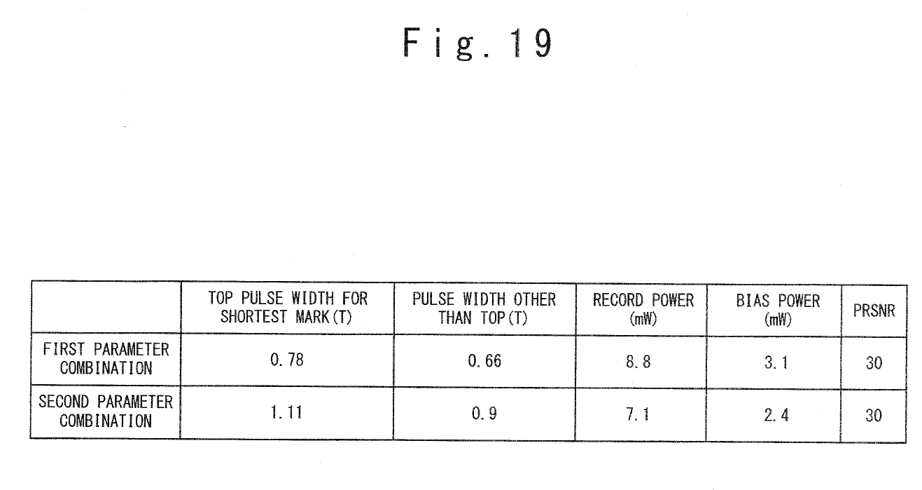

In addition, regarding a plurality of the optical discs 14 applicable to the above-mentioned exemplary embodiments, there is a plurality of parameter configurations (combinations) showing a nearly equal performance. FIG. 19 is a table showing an example of the parameter configurations. FIG. 19 shows a correspondence relationship of optimum values of: the record power; and the bias power regarding each combination of a case where the combination of the top pulse and another pulse is changed Referring to FIG. 19, the shortest mark top pulse width is shown to be approximately 1.2 times as broad as a pulse width other than the top pulse width.

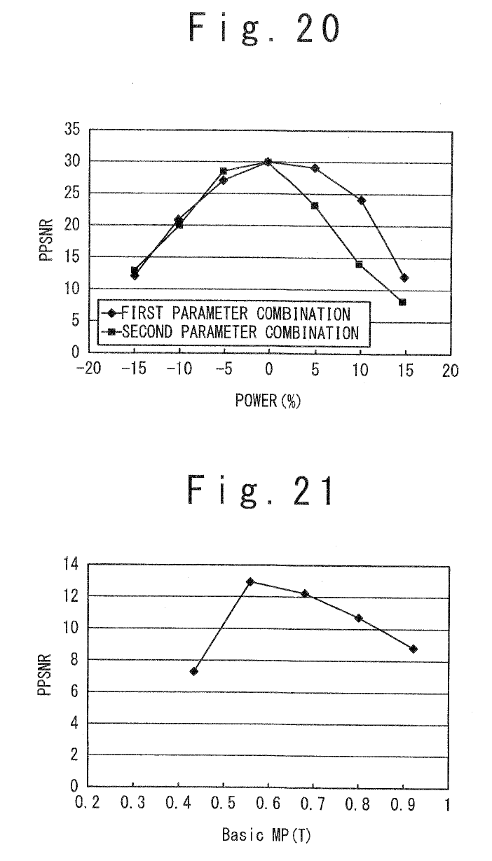

Moreover, FIG. 20 shows power margins in using respective parameters. This shows that the first parameter combination has a broader power margin than that of the second parameter combination. As shown in the result of FIG. 20, it is desirable that the basic pulse width is as narrow as possible (slim) and the record power is as high as possible.

In a case where the pulse width is broad, a size of the recording mark is ensured (formed) even when the power is not sufficiently high. As the result, the mark is formed before reaching a sufficient temperature to form the mark, resulting in formation of an unstable mark. In a case where the pulse width is slim, it is required to set the power high to ensure a size of mark to be formed. When the power is high, the temperature substantially exceeds a temperature required for the mark formation, and thereby a stable mark can be formed.

In the optical information recording and reproducing device 1, an upper limit is provided to an emission output of laser used for the recording. In this case, the information recording and reproducing device 1 has to maximize a performance of medium under the limit of emission output. When a power range and a pulse width to be intensively searched are determined for an optimum record power, it is preferred to adjust the basic pulse width to be narrow (slim); and the record power to be high.

FIG. 21 is a result obtained by measuring the PRSNR in changing a pulse width to determine the base strategy. In the information recording and reproducing device 1 in the present comparative example, the maximum power of the record power that can be emitted is 12 mW. In this case, the record power is 9 mW in consideration of the power margin of the optical disc 14, temporal changes, environmental changes, and the like. In addition, when this base strategy is determined, the PRML detection is carried out through the asymmetry corrector 24, and the PRSNR is measured.

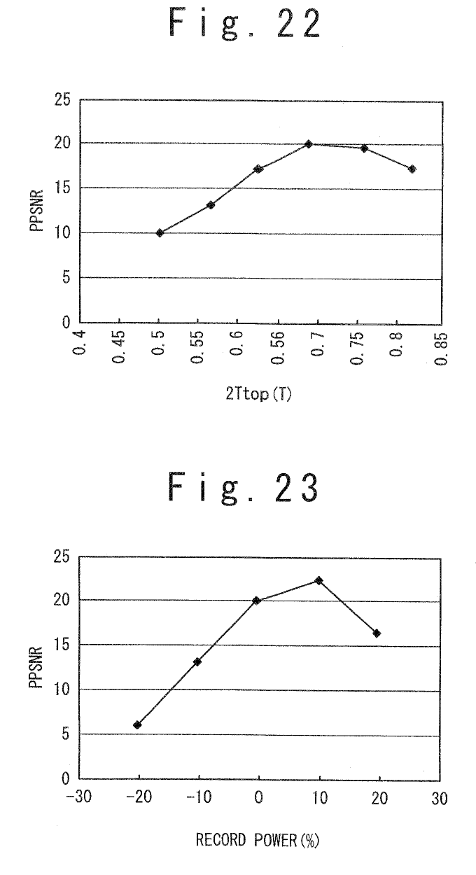

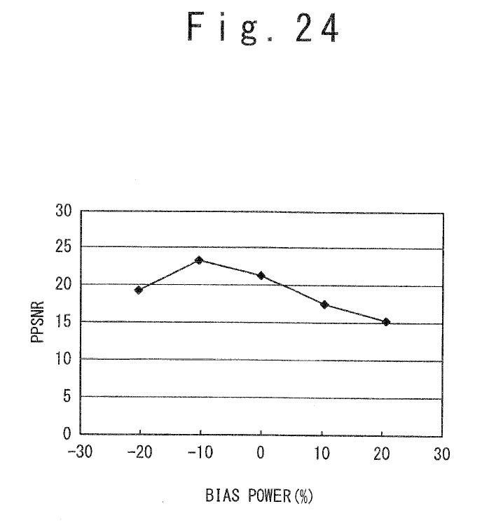

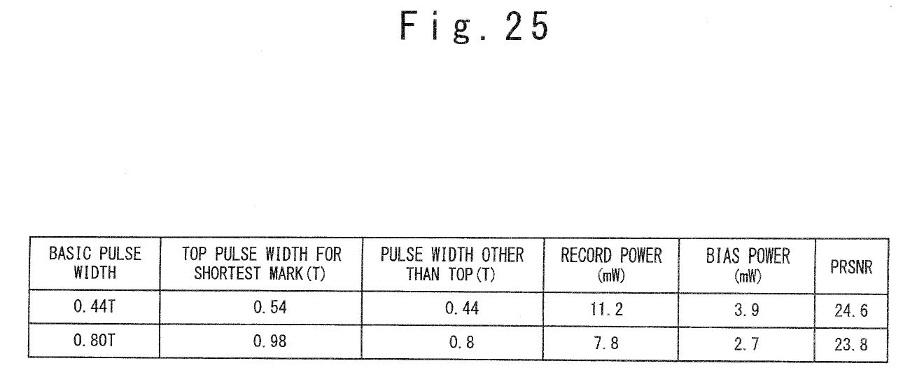

Referring to FIG. 21, it is shown that the base performance can be obtained as 0.56 T. Meanwhile, the PRSNR is used as signal quality because of standards of the HD DVD that uses the PRML detection, however, an error rate, the number of errors (the number of bytes), and a PI error may be obviously used. Next, a result obtained when a width of 2 T top pulse is changed based on 0.56 T among pulses corresponding to 2 T pattern that is the shortest mark of the ETM modulation is shown in FIG. 22. FIG. 22 shows that a best result can be obtained at 0.69 T. Results obtained by adjusting (step S103) the recording power after that are shown in FIGS. 23 and 24. Referring to FIGS. 23 and 24, it is shown that the PRSNR as a final performance is approximately 24. For reference, a result obtained by adjusting the parameter in the cases of the basic pulse widths of 0.44 T and 0.80 T are shown in FIG. 25.

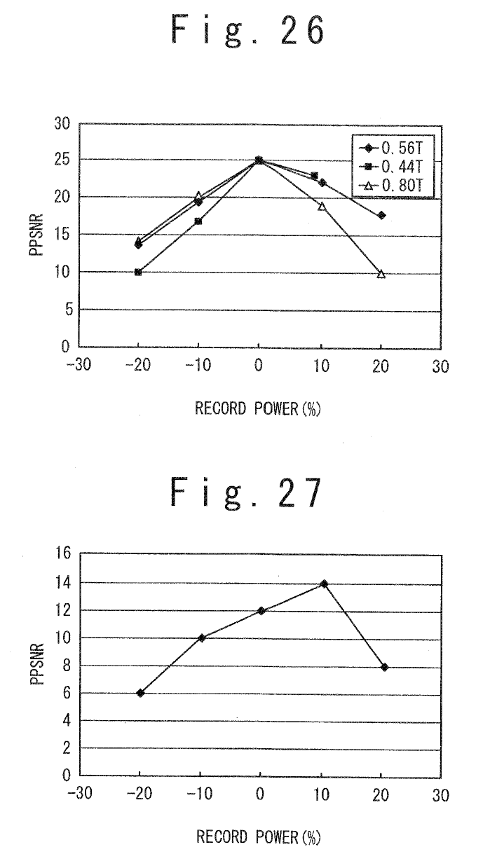

FIG. 26 shows results of measurement of record power margins obtained when the basic pulse widths are 0.44 T, 0.56 T, and 0.80 T. Referring to FIG. 26, it is shown that: the margin is broad when the basic pulse width is 0.56 T; the recording strategy is better overall; and the adjustment method of a present invention is effective. Meanwhile, in the case where the basic pulse width is 0.44 T, the power exceeds the maximum emission limit of 12 mW. For this reason, the measurement at +20% is not carried out.

Here, a result of the case where the adjustment of the recording power at step S103 is carried out at a time when the base strategy is determined prior to the adjustment of 2 T top at step S102 as described in the above-mentioned seventh exemplary embodiment is shown in FIG. 27. Referring to FIG. 27, when the adjustment of the recording power at step S103 is carried out before the adjustment of 2 T top at step S102, the PRSNR shows the best value at +10%. Subsequently, the bias power is adjusted, and even when step S102 Is carried out after that, the similar parameter can be selected.

Accordingly, it is found that the recording power may be interchangeable in the adjustment method of strategy as in the seventh exemplary embodiment. Additionally, the adjustment of the recording power here (step S103) is considered as a fine adjustment of strategy based on a frame. Moreover, a setting step of the pulse width is restricted in the device. In contrast, since the power can be set at more fine setting steps, the power can be said to be suitable for the fine adjustment.

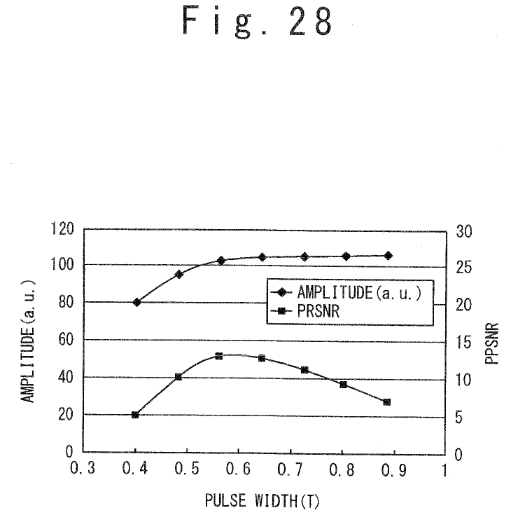

FIG. 28 shows a result obtained by plotting the PRSNR and an amplitude of 8 T pattern each obtained when the recording power is fixed and the basic pulse width is changed at obtaining the base strategy. Meanwhile, FIG. 28 shows a result obtained when a medium other than the optical disc 14 used in the above-mentioned comparative example is used. Referring to FIG. 28, as the pulse width increases, a change rate of an amplitude changes, and a time when the change rate becomes approximately constant and a time when the PRSNR (at this moment) becomes the highest roughly coincide with each other, thereby it is roughly shown that an amplitude of pattern having a certain length or more (for example, 4 T or be) may be basically used.

In addition, the information recording and reproducing device 1 can identify a maker name by using an ID retained in a medium. Accordingly, a recording condition parameter in the device can be preliminarily related to a maker of a medium. When the adjustment is carried out by setting a width of a top pulse corresponding to the shortest mark to be approximately 1.2 times as broad as the basic pulse after the basic pulse width is specified by the adjustment and a frame is determined on the basis of the correspondence relationship, the adjustment can be carried out at higher speed.

A person skilled in the art is able to easily carry out various modifications of the above-mentioned exemplary embodiments. Accordingly, the present invention is not limited to the above-mentioned exemplary embodiments, and is interpreted within the broadest scope considered on the basis of the claims and equivalents.

This application claims the priority based on Japanese Patent Application No. 2007-11318 filed on Jan. 22, 2007, and the disclosures of Japanese Patent Application No. 2007-11318 are hereby incorporated by reference.

1-26. (canceled)

27. A recording strategy adjustment method for adjusting a recording strategy to specify an output waveform of a laser beam irradiated to a recording layer of an information recording medium comprising:
determining a basic recording strategy;
setting a width of a top pulse being a pulse for recording a shortest mark with specifying the shortest mark in a pattern string formed on a recording layer of the information recording medium after the determining; and
adjusting a recording power including a record power and a bias power.

28. The recording strategy adjustment method according to claim 27, further comprising:
selecting a pulse train type recording strategy, and the determining comprises:
setting the recording power to a predetermined power;
recording a predetermined test pattern string by uniformly changing either one of an anterior edge or a posterior edge of each pulse in a middle pulse in a predetermined range stepwisely at a predetermined pitch with specifying the middle pulse being a pulse string except a top pulse and a last pulse among a plurality of pulses represented in the pulse train type recording strategy, and;
measuring a reproduction signal quality corresponding to a pulse width at each step of the changing by reproducing the test pattern string recorded at the recording the predetermined test pattern string by uniformly changing either one of the anterior edge or the posterior edge; and
setting the middle pulse by setting the pulse width which is used when a pattern string which indicates a best reproduction signal quality among the reproduction signal quality measured at the measuring the reproduction signal quality corresponding to the pulse width is recorded as a basic pulse width.

29. The recording strategy adjustment method according to claim 27, comprising:
selecting a pulse train type recording strategy as the basic recording strategy,
wherein the determining comprises:
recording a predetermined test pattern string by fixing the bias power and by changing the recording power stepwisely with setting a predetermined pulse width as a uniform basic pulse width for at least the middle pulse, and;
measuring a reproduction signal quality corresponding to each recording power which are changed stepwisely by reproducing the pattern string recorded at the recording the predetermined test pattern string by fixing the bias power and by changing the recording power; and
setting a recording power which is used when a pattern string which indicates a best reproduction signal quality among the reproduction signal quality measured at the measuring the reproduction signal quality corresponding to each recording power to a base strategy recording power being used for a following adjustment.

30. The recording strategy adjustment method according to claim 28, wherein the setting the width of the top pulse being the pulse for recording the shortest mark comprises:
recording a pattern string formed by a mark and a space by stepwisely changing a width of a top pulse for recording the shortest mark employing the basic pulse width as a center and at a predetermined pitch in a predetermined range by taking the basic pulse width as a basic top pulse width as a reference top pulse width;
measuring the reproduction signal quality by reproducing the pattern string recorded at the recording the pattern string; and
setting a pulse width which is used when a pattern string which indicates a best reproduction signal quality among the reproduction signal quality measured at the measuring the reproduction signal quality by reproducing the pattern string is recorded as a shortest mark correspondence top pulse width.

31. The recording strategy adjustment method according to claim 28, wherein the setting the width of the top pulse being the pulse for recording the shortest mark is:
setting a basic top pulse width obtained by multiplying the basic pulse width by a predetermined coefficient as the shortest mark correspondence top pulse width.

32. The recording strategy adjustment method according to claim 28, further comprising:
setting a width of a top pulse for recording a mark longer than a shortest mark by changing a width of a top pulse for recording a mark having any length longer than a shortest mark by equal to or more than a one recording unit length (1 T) among top pulses for forming a mark on the information recording medium.

33. The recording strategy adjustment method according to claim 28, further comprising:
setting a width of a last pulse for recording a mark by changing a width of a last pulse for recording a mark having any length longer than a shortest mark by equal to or more than a one recording unit length (1 T) among last pulses for forming a mark on the information recording medium.

34. The recording strategy adjustment method according to claim 32, further comprising:
setting a width of a top pulse for recording the shortest mark once again when the pulse train type recording strategy is a (k-1) type pulse train consists of a pulse group of k-1 pulses, and a recording mark is kT (k is an integer equal to or larger than 2, and T is a channel clock period),
wherein the setting the width of the top pulse for recording the shortest mark is carried out subsequently to a top pulse width adjust step or a last pulse width adjust step for recording a mark having a length longer than a shortest pulse by equal to or more than a one recording unit length (1 T) among top pulses or last pulses for forming a mark on the information recording medium.

35. The recording strategy adjustment method according to claim 28, further comprising:
setting a width of a last pulse for recording a mark by changing a width of a last pulse for recording the shortest mark among last pulses for forming a mark on the information recording medium, when the pulse train type recording strategy is a (k) type pulse train consists of a pulse group of k (k is an integer equal to or larger than 2), and a recording mark is kT (k is an integer equal to or larger than 2, and T is a channel clock period).

36. The recording strategy adjustment method according to claim 27, further comprising:
changing a pulse width by uniformly changing either one of an anterior edge or a posterior edge of each pulse in accordance with a correspondence relationship between a predetermined recording power and a pulse width for the set top pulse, middle pulse and last pulse.

37. The recording strategy adjustment method according to claim 27, further comprising:
selecting a recording strategy of non-multi type as the basic recording strategy, and
the determining comprises:
recording a predetermined test pattern string by changing at least middle power stepwisely at which the recording power is set to a predetermined power, and a top pulse and a last pulse among pulses composing the non-multi are set to a basic pulse width,
measuring a reproduction signal quality corresponding to each middle power being changed stepwisely by reproducing the pattern string recorded at the recording the predetermined test pattern string by changing at least middle power; and
setting a middle power which is used when a pattern string which indicates a best reproduction signal quality among the reproduction signal quality measured at the measuring the reproduction signal quality corresponding to each middle power to a middle power for a base strategy used for a following adjustment.

38. The recording strategy adjustment method according to claim 28, wherein the reproduction signal quality includes any of: a modulation degree of a reproduction signal composed of a mark longer than a predetermined length and a space; and an overall amplitude of the reproduction signal.

39. The recording strategy adjustment method according to claim 28, wherein the reproduction signal quality is any of: a PRSNR value calculated based on a reproduction signal; and an error rate, which are obtained by reproducing the pattern string.

40. An information recording and reproducing device comprising a recording strategy adjustment means configured to adjust a recording strategy which specify an output waveform of a laser beam for forming a pattern string composed of a mark and a space on an information recording medium, wherein the recording strategy adjustment means comprises:
a power control means configured to control a recording power and a bias power independently;
a performance judgment means configured to judge a signal quality of a reproduced signal of a record signal; and
a record parameter change means configured to change a record parameter in accordance with a result of the performance judgment means, and
when adjusting a predetermined recording strategy at recording of a mark, the information recording and reproducing device carries out the followings:
a base strategy determination process of determining a basic recording strategy;
a first top pulse width set process of setting a width of a top pulse being a pulse for recording a shortest mark with specifying the shortest mark in a pattern string formed on a recording layer of the information recording medium after the determining; and
a first recording power adjustment process of adjusting a recording power including a record power and a bias power.

41. The information recording and reproducing device according to claim 40, wherein the basic recording strategy is a pulse train type recording strategy, and
the base strategy determination process comprises:
a first recording process of: recording a predetermined test pattern string by uniformly changing either one of an anterior edge or a posterior edge of each pulse in at least a middle pulse in a predetermined range stepwisely at a predetermined pitch with specifying the middle pulse being a pulse string except a top pulse and a last pulse among pulses constituting the pulse train;
a first measurement process of measuring a reproduction signal quality corresponding to a pulse width at each step of the changing by reproducing the test pattern string recorded at the first recording process; and
a basic pulse width set process of setting the middle pulse by setting the pulse width which is used when a pattern string which indicates a best reproduction signal quality among the reproduction signal quality measured at the measuring the reproduction signal quality corresponding to the pulse width is recorded as a basic pulse width.

42. The information recording and reproducing device according to claim 40, wherein the basic recording strategy is a pulse train type recording strategy, and
the determining comprises:
a second recording process of recording a predetermined test pattern string by fixing the bias power and by changing the recording power stepwisely with setting a predetermined pulse width as a uniform basic pulse width for at least the middle pulse, and;
a second measurement process of measuring a reproduction signal quality corresponding to each recording power which are changed stepwisely by reproducing the pattern string recorded at the second recording process; and
a base strategy recording power set process of setting a recording power which is used when a pattern string which indicates a best reproduction signal quality among the reproduction signal quality measured at the second measurement process to a base strategy recording power being used for a following adjustment.

43. The information recording and reproducing device according to claim 41, wherein the first top pulse width set process comprises:
a third recording process of recording a pattern string formed by a mark and a space by stepwisely changing a width of a top pulse for recording the shortest mark employing the basic pulse width as a center and at a predetermined pitch in a predetermined range by taking the basic pulse width as a basic top pulse width as a reference top pulse width;
a third measurement process of measuring the reproduction signal quality by reproducing the pattern string recorded at the third recording process; and
a process of setting a pulse width which is used when a pattern string which indicates a best reproduction signal quality among the reproduction signal quality measured at the third measurement process is recorded as a shortest mark correspondence top pulse width.

44. The information recording and reproducing device according to claim 41, wherein the first top pulse width set process is:
a process of setting a basic top pulse width obtained by multiplying the basic pulse width by a predetermined coefficient as the shortest mark correspondence top pulse width.

45. The information recording and reproducing device according to claim 41, further comprising:
a second top pulse width set process of setting a width of a top pulse for recording a mark longer than a shortest mark by changing a width of a top pulse for recording a mark having any length longer than a shortest mark by equal to or more than a one recording unit length (1 T) among top pulses for forming a mark on the information recording medium.

46. The information recording and reproducing device according to claim 41, further comprising:
a last pulse width set process of setting a width of a last pulse for recording a mark by changing a width of a last pulse for recording a mark having any length longer than a shortest mark by equal to or more than a one recording unit length (1 T) among last pulses for forming a mark on the information recording medium.

47. The information recording and reproducing device according to claim 45, further comprising:
a third top pulse width set process of setting a width of a top pulse for recording the shortest mark once again when the pulse train type recording strategy is a (k-1) type pulse train consists of a pulse group of k-1 pulses, and a recording mark is kT (k is an integer equal to or larger than 2, and T is a channel clock period),
wherein the third top pulse width set process is carried out subsequently to a top pulse width adjust step or a last pulse width adjust step for recording a mark having a length longer than a shortest pulse by equal to or more than a one recording unit length (1 T) among top pulses or last pulses for forming a mark on the information recording medium.

48. The information recording and reproducing device according to claim 41, further comprising:
a last pulse width set process of setting a width of a last pulse for recording a mark by changing a width of a last pulse for recording the shortest mark among last pulses for forming a mark on the information recording medium, when the pulse train type recording strategy is a (k) type pulse train consists of a pulse group of k (k is an integer equal to or larger than 2), and a recording mark is kT (k is an integer equal to or larger than 2, and T is a channel clock period).

49. The information recording and reproducing device according to claim 40, further comprising:
an all pulse widths uniform adjustment process of changing a pulse width by uniformly changing either one of an anterior edge or a posterior edge of each pulse in accordance with a correspondence relationship between a predetermined recording power and a pulse width for the set top pulse, middle pulse and last pulse.

50. The information recording and reproducing device according to claim 40, wherein the basic recording strategy is a recording strategy of non-multi type, and
the base strategy determination process comprises:
a fourth recording process of recording a predetermined test pattern string by changing at least middle power stepwisely at which the recording power is set to a predetermined power, and a top pulse and a last pulse among pulses composing the non-multi are set to a basic pulse width,
a fourth measurement process of measuring a reproduction signal quality corresponding to each middle power being changed stepwisely by reproducing the pattern string recorded at the fourth recording process; and
a middle power set process of setting a middle power which is used when a pattern string which indicates a best reproduction signal quality among the reproduction signal quality measured at the fourth measurement process to a middle power for a base strategy used for a following adjustment.

51. The information recording and reproducing device according to claim 41, wherein the reproduction signal quality includes any of: a modulation degree of a reproduction signal composed of a mark longer than a predetermined length and a space; and an overall amplitude of the reproduction signal.

52. The information recording and reproducing device according to claim 41, wherein the reproduction signal quality is any of: a PRSNR value calculated based on a reproduction signal; and an error rate, which are obtained by reproducing the pattern string.
